(19) United States
(12) Patent Application Publication
(10) Pub. No.: US 2020/0037638 A1
(43) Pub. Date: Feb. 6, 2020

(54) FORMULATIONS

(71) Applicant: Molecular Infusions, LLC., Franklin, MA (US)

(72) Inventors: William Stephen Faraci, Arlington, MA (US); Stephen E. Zale, Hopkinton, MA (US); Abhimanyu Paraskar, Arlington, MA (US); Tuna Yucel, Medford, MA (US); Nicholas J. Boylan, Boylston, MA (US)

(21) Appl. No.: 16/537,916

(22) Filed: Aug. 12, 2019

Related U.S. Application Data
(63) Continuation of application No. PCT/US2018/018382, filed on Feb. 15, 2018.
(60) Provisional application No. 62/459,086, filed on Feb. 15, 2017.
(60) Provisional application No. 62/546,149, filed on Aug. 16, 2017.

(51) Int. Cl. A23L 2/52; A23L 33/105; A23L 29/00

(52) U.S. Cl. CPC A23L 2/52; A23L 29/035; A23L 33/105

(57) ABSTRACT

The invention provides for cannabinoid formulations, including self-emulsifying formulations and micellar dispersions, as well as methods of making and using the same. The formulations comprise a cannabinoid and surfactant. The formulations have improved dissolution, stability, and pharmacokinetics, including absorption and/or oral bioavailability. The invention also provides for formulations comprising at least one active ingredient, including self-emulsifying formulations and micellar dispersions, as well as methods of making and using the same. The formulations comprise a least one active ingredient and surfactant.

### CROSS-REFERENCE TO RELATED APPLICATIONS

This application is a continuation of International Application No. PCT/US2018/018382 filed on Feb. 15, 2018, which claims the benefit of U.S. Provisional Patent Application No. 62/459,086, filed Feb. 15, 2017 and 62/546,149, filed Aug. 16, 2017. The entire teachings of the above applications are incorporated herein by reference.

### FIELD OF THE INVENTION

The present invention relates to compositions comprising at least one active ingredient, e.g., a cannabinoid, cannabinoid extract, terpene, terpene extract, or other active ingredient and a surfactant, as well as methods of making and using the same. The compositions include self-emulsifying formulations and formulations that form micelle solution/dispersions. The compositions of the present invention are suitable for oral administration. The compositions increase drug solubilization through colloidal or micellular dispersion. The compositions may reduce the time of onset, effect of food on absorption, and potentially lower hepatic first-pass metabolism of the cannabinoid and/or other active ingredient(s), thereby improving bioavailability.

### BACKGROUND OF THE INVENTION

Self-emulsifying drug delivery systems (SEDDS) provides a means to enhance the dissolution of some actives in an aqueous environment. Examples of patents demonstrating the potential use of SEDDS or lipid delivery systems for lipophilic drugs include U.S. Pat. Nos. 5,484,801; 5,798,333; 5,965,160; 6,008,228; 6,730,330; 9,265,724; U.S. Patent Application No. 20050209345; 20060160888; US20140357708; 20160184258; and PCT Publications WO96/39142 and WO2016147186. United States Patent U.S. Pat. No. 9,265,724 and U.S. Patent Application 20160184258 exemplify a few SEDDS formulations comprising Δ9 THC.

Cannabinoids are a class of active compounds derived from the Cannabis sativa, Cannabis indica, or Cannabis hybrid plant commonly known as marijuana. The most notable cannabinoid is the phytocannabinoid tetrahydrocannabinol (THC), the primary psychoactive compound in cannabis. Delta-9-tetrahydrocannabinol (Δ9-THC) and delta-8-tetrahydrocannabinol (Δ8-THC) mimic the actions of anandamide and 2-arachidonoylglycerol neurotransmitters produced naturally in the body. These cannabinoids produce the effects associated with cannabis by binding to the CB1 cannabinoid receptors in the brain.

Cannabidiol (CBD) is another major constituent of the cannabis plant. Other cannabinoids include Cannabigerol (CBG), Cannabichromene (CBC), Cannabicyclol (CBL), Cannabivarin (CBV), Tetrahydrocannabivarin (THCV), Cannabidivarin (CBDV), Cannabichromevarin (CBCV), Cannabigerovarin (CBGV), Cannabigerol Monomethyl Ether (CBGM), Tetrahydrocannabinolic acid (THCA), cannabinol (CBN), and Cannabidiolic Acid (CBDA).

Synthetic Δ9-tetrahydrocannabinol (dronabinol) is marketed under the trade name MARINOL®. Dronabinol is approved by the Food and Drug Administration (FDA) for the control of nausea and vomiting associated with chemotherapy and for appetite stimulation of AIDS patients suffering from the wasting syndrome. MARINOL is a formulation of dronabinol in sesame oil presented as a soft gelatin capsule for oral administration. After oral administration, dronabinol has an onset of action of approximately 0.5 to 1 hours and peak effect at 2 to 4 hours. Duration of action for psychoactive effects is 4 to 6 hours, but the appetite stimulant effect of dronabinol may continue for 24 hours or longer after administration. Dronabinol is almost completely absorbed (90 to 95%) after single oral doses. Due to the combined effects of first pass hepatic metabolism and high lipid solubility, only 10 to 20% of the administered dose reaches the systemic circulation.

There is a need for additional, preferably less complex, self-emulsifying and micellar dispersion forming formulations, particularly those that are more stable, faster acting (i.e., have a faster onset of action), avoid or reduce hepatic first-pass metabolism, deliver more of the active ingredient(s) to the lymphatic system, or increase oral bioavailability for treating a variety of conditions. The present invention addresses this need by providing improved formulations for use in a variety of conditions including pain, nausea and vomiting.

### SUMMARY OF THE INVENTION

A first aspect provides a composition comprising:

at least one active ingredient; and

a surfactant.

In one embodiment, the at least one active ingredient is selected from a cannabinoid, cannabinoid extract, terpene, or terpene extract.

In one embodiment, the composition comprises:

at least one active ingredient;

a surfactant; and

a fatty acid, monoglyceride, diglyceride, triglyceride, or a combination thereof.

In one embodiment, the at least one active ingredient is selected from a cannabinoid, cannabinoid extract, terpene, or terpene extract.

In another embodiment, the composition is a non-aqueous formulation. In another embodiment, the composition is a pharmaceutical composition, preferably an oral dosage form, more preferably a solid or semi-solid oral dosage form. Another embodiment, relates to a unit dose of the composition.

A second aspect provides a method of making the composition of the first aspect comprising the steps of:

providing at least one active ingredient, a surfactant, and, optionally, a fatty acid, monoglyceride, diglyceride, triglyceride, or a combination thereof;

combining said at least one active ingredient, said surfactant and, optionally, a fatty acid, monoglyceride, diglyceride, triglyceride, or a combination thereof to form a homogeneous or isotropic mixture.

In one embodiment, the active ingredient is selected from a cannabinoid, cannabinoid extract, terpene, or terpene extract.

A third aspect provides for a composition and method for a composition for promoting sleep, reducing stress, and/or reducing anxiety; the composition comprising THC, CBD, CBN and, optionally, at least one additional active ingredient. In one embodiment, the composition further comprises one or more terpenes, preferably myrcene and limonine. In a further embodiment, the composition further comprises melatonin.

A fourth aspect provides for a method of treating or preventing a condition in an animal, e.g., human, including pain, nausea, and/or vomiting, comprising the step of administering to said animal an effective amount of a composition of the first or third aspect.

In certain embodiments, the composition is a non-aqueous composition, a pharmaceutical composition, a unit dose, an oral dosage form, or more preferably, a solid or semi-solid, non-aqueous, oral dosage form.

### BRIEF DESCRIPTION OF THE FIGURES

FIG. 1. Emulsion particle size as a function of HLB number. Formulation surfactant content of 50 vol. % and aqueous emulsion concentration of 1.0 vol. %. Open and solid circles denote Polysorbate—Span 80 blends and pure polysorbates, respectively.

FIG. 2. Emulsion particle size as a function of HLB number at an aqueous emulsion concentration of 1.0 vol. %. Formulation surfactant content for squares, triangles and x symbols were 50, 75 and 90 vol. %, respectively.

FIG. 3. Particle size vs. turbidity rank for 1.0 vol. % emulsions.

FIG. 4. Emulsion particle size as a function of HLB number at an aqueous emulsion concentration of 0.1 vol. %. Formulation surfactant content for squares, triangles and x symbols were 50, 75 and 90 vol. %, respectively.

FIG. 5. Particle size vs. turbidity rank for 0.1 vol. % emulsions.

FIG. 6. Dilutability as a function of HLB number at an aqueous emulsion concentration of 1.0 vol. %. Formulation surfactant content for squares, triangles and x symbols were 50, 75 and 90 vol. %, respectively.

### DETAILED DESCRIPTION OF THE INVENTION

The present invention relates to compositions comprising at least one active ingredient, preferably, a cannabinoid or cannabinoid extract, and a surfactant. The compositions include self-emulsifying compositions, e.g., self-emulsifying drug delivery systems (SEDDS), oil-free, swollen micellar dispersions, comprising at least one active ingredient, e.g., cannabinoid. Some of the compositions comprise a fatty acid, monoglyceride, diglyceride, triglyceride, or a combination thereof. The compositions that comprise a triglyceride include compositions that comprise a medium chain triglyceride or a long chain triglyceride. In the presence of an aqueous solvent some of the compositions produce emulsions via self-emulsifying mechanisms. The compositions, including self-emulsifying drug delivery systems (SEDDS) and micelles, of the present invention enhance oral bioavailability by the formation of colloidal dispersions, thus increasing solubility of an active ingredient. The compositions of the present invention include formulations that avoid hepatic first-pass metabolism, in part, by targeting chylomicron/lipoprotein delivery. The compositions of the present invention include formulations that have a faster onset of action—the time it takes an active ingredient to reach a minimum effective concentration after the active ingredient is administered. The compositions of the present invention include formulations that have greater stability, greater oral bioavailability, or reduced individual variability of bioavailability, e.g., by reducing food-effect, greater efficacy, or, in the case of THC, a more intense psychotropic effect as compared to MARINOL® and may be formulated for immediate release.

The compositions of the present invention comprise at least one active ingredient and a surfactant. Non-limiting examples of active ingredients for inclusion in the compositions of the invention include: a cannabinoid, cannabinoid extract, terpene, terpene extract, an anti-insomnia, an anti-tussive, an opioid analgesic, a decongestant, a non-opioid analgesic/anti-inflammatory drug, anti-migraine drug, an anti-emetic, an anti-histamine, a proton pump inhibitors (PPI), a H₂ antagonist/H₂ blocker, a tranquilizer, an anti-convulsant, a hypnotic, a muscle relaxant, an anti-psychotic, an anti-diarrheal, an Attention Deficit and Hyperactivity Disorder (ADHD) drug, an anti-Parkinson disease drug, a benzodiazepine, a benzodiazepine antagonist, a barbiturate, a barbiturate antagonist, a stimulant, a stimulant antagonist, an antidepressant, a nutraceutical, nicotine, a BCS Class II active ingredient, a BCS Class IV active ingredient or combinations thereof. In various embodiments, active ingredients found within a category described herein can be combined within the compositions of the invention (e.g., combinations of anti-insomnia drugs). Other embodiments provide for the combination of active ingredients within any number of the categories described herein (e.g., one or more compound within the anti-insomnia category and one or more compound within the non-opioid analgesic/anti-inflammatory drug category).

In one embodiment, the active ingredient is an anti-insomnia. In further embodiments, the anti-insomnia is selected from any one of: melatonin, trazodone, zolpidem, temazepam, elprazolam, amitriptyline, halcion, lorazepam, clonazepam, Intermezzo, eszopiclone, diphenhydramine, doxepin, mirtazapine, gabapentin, doxylamine, quetiapine, flurazepam, estazolam, olanzapine, Seconal, triazolam, zaleplon, secobarbital, chloral hydrate, oxazepam, quazepam, ramelteon, suvorexant, butabarbital, pentobarbital, phenobarbital, phenyltoloxamine, amobarbital, diphenhydramine, dimenhydrinate, diphenhydramine/magnesium salicylate, diphenhydramine/naproxen, diphenhydramine/aspirin, diphenhydramine/paracetamol, diphenhydramine/ibuprofen, tasimelteon, or combinations thereof.

In one embodiment, the active ingredient is an anti -tussive. In further embodiments, the anti -tussive is selected from any one of: benzonatate, caramiphen edisylate, chlophedianol, codeine, dextromethorphan hydrobromide, hydrocodone, levopropoxyphene, morphine, codeine, ethylmorphine, dihydrocodeine, benzylmorphine, laudanum, dihydroisocodeine, nicocodeine, nicodicodeine, hydrocodone, hydromorphone, acetyldihydrocodeine, thebacon, diamorphine (heroin), acetylmorphone, noscapine, pholcodine, or combinations thereof.

In one embodiment, the active ingredient is an opioid analgesic. In further embodiments, the opioid analgesic is selected from any one of: alfentanil, allylprodine, alphaprodine, anileridine, benzylmorphine, bezitramide, buprenorphine, butorphanol, clonitazene, codeine, desomorphine, dextromoramide, dezocine, diampromide, diamorphone, dihydrocodeine, dihydromorphine, dimenoxadol, dimepheptanol, dimethylthiambutene, dioxaphetyl butyrate, dipipanone, eptazocine, ethoheptazine, ethylmethylthiambutene, ethylmorphine, etonitazene, fentanyl, hydrocodone, hydromorphone, hydroxypethidine, isomethadone, ketobemidone, levorphanol, levophenacylmorphan, lofentanil, meperidine, meptazinol, metazocine, methadone, metopon, morphine, myrophine, nalbuphine, narceine, nicomorphine, norlevorphanol, normethadone, nalorphine, normorphine, norpipanone, opium, oxycodone, oxymorphone, papaveretum, pentazocine, phenadoxone, phenomorphan, phenazocine, phenoperidine, piminodine, piritramide, proheptazine, promedol, properidine, propiram, propoxyphene, sufentanil, tilidine, tramadol, or combinations thereof.

In one embodiment, the active ingredient is a decongestant. In further embodiments, the decongestant is selected from any one of: pseudoephedrine hydrochloride, phenylephrine bitartrate, phenylephrine hydrochloride, pseudoephedrine sulfate, or combinations thereof.

In one embodiment, the active ingredient is a non-opioid analgesic/anti-inflammatory drug. In further embodiments, the non-opioid analgesic/anti-inflammatory is selected from any one of: acetaminophen or a non-steroidal anti-inflammatory agent selected from the group consisting of aspirin, celecoxib, ibuprofen, diclofenac, naproxen, benoxaprofen, flurbiprofen, fenoprofen, flubufen, ketoprofen, indoprofen, piroprofen, carprofen, oxaprozin, pramoprofen, muroprofen, trioxaprofen, suprofen, aminoprofen, tiaprofenic acid, fluprofen, bucloxic acid, indomethacin, sulindac, tolmetin, zomepirac, tiopinac, zidometacin, acemetacin, fentiazac, clidanac, oxpinac, mefenamic acid, meclofenamic acid, flufenamic acid, niflumic acid, tolfenamic acid, diflurisal, flufenisal, piroxicam, sudoxicam, isoxicam, or combinations thereof.

In one embodiment, the active ingredient is an anti-migraine drug. In further embodiments, the anti-migraine drug is selected from any one of: 2-bromo-LSD, acetaminophen/dichloralphenazone/isometheptene mucate, almotriptin, alniditan, amidrine, avitriptan, caffeine/ergotamine, calcitonin gene-related peptide receptor antagonist, clonidine, dasolampanel, dihydroergotamine, dimetotiazine, donitriptan, dotarizine, eletriptan, ergotamine, ergotamine/chlorcyclizine/caffeine, flumedroxone acetate, iprazochrome, lasmiditan, lisuride, lomerizine, methysergide, migraleve, naratriptan, naproxen, naproxen/sumatripta, olcegepant, oxetorone, paracetamol/metoclopramide, prochlorperazine, promethazine, proxibarbital, rimegepant, rizatriptan, selurampanel, sumatriptan, telcagepant, tezampanel, topiramate, zolmitriptan, or combinations thereof.

In one embodiment, the active ingredient is an anti-emetic. In further embodiments, the anti-emetic is selected from any one of: dolasetron, granisetron, ondansetron, tropisetron, palonosetron, mirtazapine, metoclopramide, cyclizine, diphenhydramine, dimenhydrinate, meclizine, promethazine, hydroxyzine, or combinations thereof.

In one embodiment, the active ingredient is an anti-histamine. In further embodiments, the anti-histamine is selected from any one of: diphenhydramine, loratadine, desloratadine, meclizine, fexofenadine, pheniramine, cetirizine, promethazine, brompheniramine, clemastine fumarate, chlorpheniramine, or combinations thereof.

In one embodiment, the active ingredient is a proton pump inhibitors (PPI). In further embodiments, the PPI is selected from any one of: omeprazole, esomeprazole, pantoprazole, lansoprazole, rabeprazole, or combinations thereof.

In one embodiment, the active ingredient is a H₂ antagonist/H₂ blocker. In further embodiments, the H₂ antagonist/H₂ blocker is selected from any one of: cimetidine, ranitidine, famotidine, or combinations thereof.

In one embodiment, the active ingredient is a tranquilizer. In further embodiments, the tranquilizer is selected from any one of: amobarbital, pentobarbital, secobarbital, phenobarbital, clonazepam, diazepam, estazolam, flunitrazepam, lorazepam, midazolam, nitrazepam, oxazepam, triazolam, temazepam, chlordiazepoxide, alprazolam, or combinations thereof.

In one embodiment, the active ingredient is an anti-convulsant. In further embodiments, the anti-convulsant is selected from any one of: elbamate, carbamazepine, oxcarbazepine, vigabatrin, progabide, tiagabine, topiramate, gabapentin, pregabalin, ethotoin, phenytoin, valproic acid, lamotrigine, or combinations thereof.

In one embodiment, the active ingredient is a hypnotic. In further embodiments, the hypnotic is selected from any one of: zolpidem, zaleplon, zopiclone, eszopiclone, or combinations thereof.

In one embodiment, the active ingredient is a muscle relaxant. In further embodiments, the muscle relaxant is selected from any one of: methocarbamol, carisoprodol, chlorzoxazone, cyclobenzaprine, gabapentin, metaxalone, orphenadrine, or combinations thereof.

In one embodiment, the active ingredient is an anti-psychotic. In further embodiments, the anti-psychotic is selected from any one of: haloperidol, droperidol, chlorpromazine, fluphenazine, perphenazine, prochlorperazine, thioridazine, trifluoperazine, mesoridazine, promazine, triflupromazine, levomepromazine, methotrimeprazine, pimozide, chlorprothixene, flupenthixol, thiothixene, zuclopenthixol, clozapine, olanzapine, risperidone, quetiapine, ziprasidone, amisulpride, asenapine, paliperidone, or combinations thereof.

In one embodiment, the active ingredient is an anti-diarrheal. In further embodiments, the anti-diarrheal is bismuth subsalicylate, loperamide, or combinations thereof.

In one embodiment, the active ingredient is an Attention Deficit and Hyperactivity Disorder (ADHD) drug. In further embodiments, the ADHD drug is selected from any one of: methylphenidate, dextroamphetamine sulfate, amphetamine, atomoxetine hydrochloride, or combinations thereof.

In one embodiment, the active ingredient is an anti-Parkinson disease drug. In further embodiments, the anti-Parkinson disease drug is selected from any one of: amantadine, Apokyn, apomorphine, bromocriptine, carbidopa/levodopa, Cycloset, Duopa, entacapone/levodopa/carbidopa, Gocovri, levodopa, Mirapex, Mirapex ER, Neupro, Parlodel, pramipexole, Requip, Requip XL, ropinirole, rotigotine, Rytary, Sinemet, Sinemet CR, Stalevo, or combinations thereof.

In one embodiment, the active ingredient is a benzodiazepine. In further embodiments, the benzodiazepine is selected from any one of: alprazolam, bromazepam, chlordiazepoxide, clorazepate, diazepam, estazolam, flurazepam, halazepam, ketazolam, lorazepam, nitrazepam, oxazepam, prazepam, quazepam, temazepam, triazolam, or combinations thereof.

In one embodiment, the active ingredient is a benzodiazepine antagonist. In further embodiments, the benzodiazepine antagonist is flumazenil.

In one embodiment, the active ingredient is a barbiturate. In further embodiments, the barbiturate is selected from any one of: amobarbital, aprobarbotal, butabarbital, butalbital, methohexital, mephobarbital, metharbital, pentobarbital, phenobarbital, secobarbital, or combinations thereof.

In one embodiment, the active ingredient is a barbiturate antagonist. In further embodiments, the barbiturate is an amphetamine.

In one embodiment, the active ingredient is a stimulant. In further embodiments, the stimulant is selected from caffeine or an amphetamine, such as amphetamine, dextroamphetamine resin complex, dextroamphetamine, methamphetamine, methylphenidate, or combinations thereof.

In one embodiment, the active ingredient is a stimulant antagonist. In further embodiments, the stimulant antagonist is a benzodiazepine.

In one embodiment, the active ingredient is an antidepressant. In further embodiments, the antidepressant is selected from any one of: agomelatine, Allegron (see nortriptyline), amitriptyline, Anafranil (see clomipramine), Brintellix (see vortioxetine), Cipralex (see escitalopram), Cipramil (see citalopram), citalopram, clomipramine, Cymbalta (see duloxetine), Depefex XL (see venlafaxine), dosulepin, doxepin, duloxetine, Edronax (see reboxetine), Efexor XL (see venlafaxine), escitalopram, Faverin (see fluvoxamine), fluoxetine, fluvoxamine, Foraven XL (see venlafaxine), imipramine, isocarboxazid, lofepramine, Lomont (see lofepramine), Lustral (see sertraline), Manerix (see moclobemide), mianserin, mirtazapine, moclobemide, Molipaxin (see trazodone), Nardil (see phenelzine), nortriptyline, Oxactin (see fluoxetine), Parnate (see tranylcypromine), paroxetine, phenelzine, Politid XL (see venlafaxine), Prothiaden (see dosulepin), Prozac (see fluoxetine), Prozep (see fluoxetine), reboxetine, Seroxat (see paroxetine), sertraline, Sinepin (see doxepin), Sunveniz XL (see venlafaxine), Surmontil (see trimipramine), Tofranil (see imipramine), Tonpular XL (see venlafaxine), tranylcypromine, trazodone, trimipramine, Triptafen, Valdoxan (see agomelatine), Venadex XL (see venlafaxine), Venaxx XL (see venlafaxine), venlafaxine, Venlalic XL (see venlafaxine), ViePax (see venlafaxine), vortioxetine, Zispin (see mirtazapine). In preferred embodiments, the antidepressant is selected from any one of: citalopram (Celexa), escitalopram (Lexapro), fluoxetine (Prozac), fluvoxamine (Luvox), paroxetine (Paxil), sertraline (Zoloft), desvenlafaxine (Pristiq), duloxetine (Cymbalta), levomilnacipran (Fetzima), milnacipran (Ixel, Savella), venlafaxine (Effexor), reboxetine (Edronax), teniloxazine (Lucelan, Metatone), viloxazine (Vivalan) , or combinations thereof.

In one embodiment, the active ingredient is a nutraceutical. In further embodiments, the nutraceutical is selected from any one of: 5-methyltetrahydrofolic acid, ademetionine, adenine, adenosine monophosphate, alfacalcidol, alpha-linolenic acid, ATP, beta carotene, biotin, calcidiol, calcitriol, castor oil, cholecalciferol, choline, chondroitin sulfate, coenzyme A, coenzyme Q10, creatine, curcumin, cyanocobalamin, cystine, dihomo-gamma-linolenic acid, ephedra, ergocalciferol, eucalyptol, fish oil, folic acid, ginkgo biloba, ginkgolide-A, ginkgolide-B, ginkgolide-C, ginkgolide-J, ginkgolide-M, ginseng, ginsenoside C, ginsenoside Rb 1, ginsenoside Rg1, glutamic acid, glutathione, glycine, glycine betaine, histidine, hyperforin, icosapent, icosapent ethyl, inulin, kava, krill oil, L-Alanine, L-Arginine, L-Asparagine, L-Aspartic Acid, L-Citrulline, L-Cysteine, L-Glutamine, L-Isoleucine, L-Leucine, L-Lysine, L-Phenylalanine, L-Proline, L-Threonine, L-Tryptophan, L-Tyrosine, L-Valine, lipoic acid, lutein, melatonin, menadione, methionine, N-Acetylglucosamine, NADH, niacin, octacosanol, omega-3 fatty acids, omega-6 fatty acids, ornithine, oxitriptan, oxogluric acid, pantothenic acid, phosphatidyl serine, phosphocreatine, prasterone, pyridoxal, pyridoxal phosphate, pyridoxine, pyruvic acid, riboflavin, sage oil, serine, serotonin, sesame oil, sinecatechins, spermine, St. John's Wort, succinic acid, taurine, tetrahydrofolic acid, thiamine, tretinoin, tyramine, ubidecarenone, ubiquinol, vitamin A, vitamin C, vitamin D, vitamin E, vitamin K, or combinations thereof.

In one embodiment, the active ingredient is nicotine.

In another embodiment, the active ingredient is a BCS Class II active ingredient. In further embodiments, the BCS Class II active ingredient is selected from any one of following: aceclofenac, albendazole, amiodarone, atorvastatin, azithromycin, bicalutamide, bisacodyl, cabergoline, candesartancilexetil, carbamazepine, carvedilol, cefditoren, celecoxib, chloroquine, chlorpromazine, cilostazol, ciprofloxacin, cisapride, clarithromycin, clofazimine, clopidogrel, clozapine, cyclosporine, cyproterone, danazol, dapsone, diazepam, diclofenac, diflunisal, digoxin, diloxanide, ebastine, efavirenz, epalrestat, eprosartan, erythromycin, ethylicosapentate, ezetimibe, fenofibrate, flurbiprofen, furosemide, gefitinib, gliclazide, glimepiride, glipizide, glyburide, glyburide(glibenclamide), griseofulvin, haloperidol, hydroxyzine, ibuprofen, imatinib, indinavir, indomethacin, irbesartan, isotretinoin, itraconazole, ketoconazole, ketoprofen, lamotrigine, lansoprazolei, lopinavir, loratadine, lorazepam, lovastatin, mebendazole, medroxyprogesterone, meloxicam, menatetrenone, metaxalone, metoclopramide, mosapride, mycophenolatemofetil, nabumetone, naproxen, nelfinavir, nevirapine, nicergoline, niclosamide, nifedipine, nimesulide, ofloxacin, olanzapine, orlistat, oxaprozin, phenazopyridine, phenytoin, pioglitazone, piroxicam, pranlukast, praziquantel, pyrantel, pyrimethamine, quetiapine, quinine, raloxifene, rebamipide, retinol, rifampicin, risperidone, ritonavir, rofecoxib, saquinavir, simvastatin, sirolimus, spironolactone, sulfasalazine, tacrolimus, talinolol, tamoxifen, telmisartan, teprenone, terfenadine, ticlopidine, tocopherolnicotinate, tosufloxacin, triflusal, ursodeoxycholicacid, valproicacid, valsartan, verapamil, warfarin, zaltoprofen, or combinations thereof.

In another embodiment, the active ingredient is a BCS Class IV active ingredient. In further embodiments, the BCS Class IV active ingredient is selected from any one of following: acetaminophen (paracetamol), acetazolamide, acetylsalicylic acid, acyclovir, allopurinol, aluminium hydroxide, amoxicillin, azathioprine, cefdinir, cefixime, cefotiam, cefpodoxime, cefuroxime axetil, dapsone, dexamethasone, doxycycline, famotidine, folic acid, hydrochlorothiazide, 1-carbocysteine, levodopa, linezolid, mesalamine, methylphenidate, metronidazole, modafinil, nalidixic acid, nitrofurantoin, nystatin, oxcarbazepine, oxycodone, phenobarbital, propylthiouracil, roxithromycin, sulfadiazine, sulfamethoxazole, sulpiride, sultamicillin, theophylline, trimethoprim, or combinations thereof.

In one embodiment, the composition comprises a cannabinoid or cannabinoid extract and a surfactant. In various additional embodiments, the compositions may, optionally, include one or more additional active ingredients. The compositions of the present invention form emulsions, preferably nanoemulsions, microemulsions, or micelle dispersions in an aqueous solution.

In another embodiment, the composition is a non-aqueous formulation, i.e., the composition does not contain water. In certain embodiments, the composition comprises less than; 10 wt %, 9 wt %, 8 wt %, 7 wt %, 6 wt %, 5 wt %, 4 wt %, 3 wt %, 2 wt %, 1 wt %, 0.5 wt %, 0.25 wt %, 0.1 wt %, or 0.05 wt % water.

In another embodiment, the composition is a pharmaceutical composition, preferably an oral dosage form, more preferably a solid or semi-solid oral dosage form. Another embodiment includes a unit dose of the composition.

In one embodiment, the cannabinoid is in the form of an extract from a cannabis plant comprising a cannabinoid, i.e., a “cannabinoid extract”. In another embodiment, the terpene is in the form of an extract from a cannabis or other plant comprising a terpene, i.e., a “terpene extract” In a further embodiment, the cannabinoid or terpene extract is from a cannabis plant selected from Cannabis sativa, Cannabis indica, or Cannabis hybrid. In one embodiment, the cannabinoid or terpene extract is an extract of Cannabis sativa. In another embodiment, the cannabinoid or terpene extract is an extract of Cannabis indica. In another embodiment, the cannabinoid or terpene extract is an extract of Cannabis hybrid. In another embodiment, the cannabinoid or terpene extract is a distillate. In a further embodiment, the cannabinoid distillate is the product of short path distillation of a cannabinoid extract. In a further embodiment, the cannabinoid or terpene is synthetic.

In further embodiments, the cannabinoid extract comprises total cannabinoid(s) in an amount selected from: 50-75 wt %, 50-99 wt %, 75-99 wt %, 75-95 wt %, 80-99 wt %, 85-99 wt %, 90-99 wt %, 85-95 wt %, 90-95 wt %, or >99 wt % total cannabinoid(s). In further embodiments, the total concentration of cannabinoid(s) in a composition of the present invention is 1-200 mg/mL. In further embodiments, the total concentration of cannabinoid(s) in a composition of the present invention is selected from: 1-5 mg/mL, 1-10 mg/mL, 1-50 mg/mL, 1-100 mg/mL, 5-50 mg/mL, 10-50 mg/mL, 10-100 mg/mL, 5-10 mg/mL, 10-15 mg/mL, 15-20 mg/mL, 20-30 mg/mL, 30-40 mg/mL, 40-50 mg/mL, 50-75 mg/mL, 75-100 mg/mL, 100-150 mg/mL, or 150-200 mg/mL. In another embodiment, the total concentration of cannabinoid(s) in a composition of the present invention is <0.001 mg/mL, 0.001-0.01 mg/mL, or 0.01-1 mg/mL.

In another embodiment, the composition further comprises a terpene(s). In a further embodiment, the terpene is found in Cannabis sativa, Cannabis indica, or Cannabis hybrid. In a further embodiment, the terpene is extracted from a species of Cannabis (e.g., Cannabis sativa, Cannabis indica, Cannabis hybrid or other). In a further embodiment, the terpene is synthetic. In a further embodiment, the terpene is selected from the group consisting of: abietane, alpha-bisabolol, alpha-phellandrene, alpha-pinene, beta-caryophyllene, beta-myrcene, beta-pinene, borneol, cadinene, camphene, camphor, carvacrol, caryophyllene acetate, caryophyllene oxide, cedrane, cembrene, citral, citronellol, copaene, dextro carvone, dextro fenchone, eucalyptol, eugenol, farnesene, gama-3-carene, gamma-terpinene, geraniol, geranyl acetate, guaiazulene, guaiene, humulene, isopulegol, labdane, limonene, linalool, longifolene, menthol, nerol, nerolidol, ocimene, ocimene, patchoulol, p-cymene, phytane, phytol, pinene, pulegone, retinal, retinol, sclarene, stemarene, stemoden, terpineol, terpinolele, terpinolene, texadiene, thymol, valencene, valencene, vetivazulene, zingiberene.

The surfactants of the present invention include pharmaceutically acceptable or food grade surfactants. Surprisingly, compositions comprising high concentrations of surfactant, including compositions containing no exogenously added fatty acid, monoglyceride, diglyceride, triglyceride, particularly, no added MCT or LCT, performed as well or better than formulations comprising an MCT or LCT.

In some embodiments, the surfactant has an HLB value greater than 9, 10, 11, 12, 13, 14, 15, 16, or greater than 16. In other embodiments, the surfactant has an HLB value between 9-17, 9-16.7, 9-16, 9-15, 9-14, 10-17, 10-16.7, 10-16, 10-15, 14-16, 14-17, 15-17, and between 10-14. In a preferred embodiment, the surfactant has an HLB value between 14-16, In a further preferred embodiment, the surfactant has an HLB value of about 15.

As used herein, when a range is set forth as “between” two values, it is understood that the range is inclusive of the end values.

In some embodiments, the surfactant is selected from: PEG 15 hydroxystearate (Solutol HS15), polyoxyl-10-Oleyl Ether (BRIJ® 97), polyethylene glycol 25 hydrogenated castor oil, polyethylene glycol (PEG) 40 hydrogenated castor oil (Kolliphor RH40, Cremophor RH40), polyethylene-polypropylene glycol (poloxamer 124), PEG 8 caprylic/capric glycerides (Labrasol), PEG 300 oleic glycerides (Labrafil M 1944), diethylene glycol monoethyl ether (Transcutol), lauroyl macrogol 32 glycerides (GELUCIRE® 44/14), polyethylene glycol 400 (PEG 400), propylene glycol laurate (Lauroglycol FCC), D-α-Tocopherol polyethylene glycol 1000 succinate (TPGS), polyethylene-polypropylene glycol (poloxamer 188), polyethylene-polypropylene glycol (poloxamer 407), polyvinyl pyrrolidone (e.g., Mw 28-34 kDa, Mw 44-54 kDa (e.g., Kollidon 30), or 1-1.5M kDa (e.g., Kollidon 90), Iota Carrageenan, Xanthan gum, locust Bean gum, Kelcogel LT100, acacia gum, guar gum, gamma-Cyclodextrin, Tracacanth gum, hydroxypropyl methylcellulose (HPMC), carboxymethyl cellulose (CMC), microcrystalline cellulose (MCC), lecithin, polyethylene-polypropylene glycol (poloxamer 124), polyethylene glycol sorbitan monolaurate (polysorbate 20, TWEEN 20), polyethylene glycol sorbitan monopalmitate (polysorbate 40, TWEEN 40), polyethylene glycol sorbitan monostearate (polysorbate 60, TWEEN 60), polyethylene glycol sorbitan tristearate (polysorbate 65, TWEEN 65), polyethylene glycol sorbitan monooleate (polysorbate 80, TWEEN 80), polyethylene glycol sorbitan trioleate (polysorbate 85, TWEEN 85), polyethylene glycol sorbitan hexaoleate, polyethylene glycol sorbitan tetraoleate, sorbitan monolaurate (Span 20), sorbitan monopalmitate (Span 40), sorbitan monostearate (Span 60), sorbitan tristearate (Span 65), sorbitane monooleate (Span 80), sorbitan trioleate (Span 85), sucrose laurate, sucrose palmitate, sucrose stearate, gamma-cyclodextrin, beta-cyclodextrin (e.g., CAPTISOL) pectin, whey protein, caseinates, quillaia/quillaj a saponins, quillaia extract, PEG 8 stearate, PEG 40 stearate, or a combination thereof.

In other embodiments, the surfactant is selected from: polyoxyl-10-Oleyl Ether (BRIJ® 97), polyethylene glycol 25 hydrogenated castor oil, polyethylene glycol (PEG) 40 hydrogenated castor oil (Kolliphor RH40, Cremophor RH40), polyethylene-polypropylene glycol (poloxamer 124), PEG 8 caprylic/capric glycerides (Labrasol), PEG 300 oleic glycerides (Labrafil M 1944), diethylene glycol monoethyl ether (Transcutol), sorbitane monooleate (Span 80), Lauroyl macrogol 32 glycerides (GELUCIRE® 44/14), polyethylene glycol 400 (PEG 400), propylene glycol laurate (Lauroglycol FCC), polysorbate 20 (TWEEN® 20), polysorbate 40 (TWEEN® 40), polysorbate 60 (TWEEN® 60), polysorbate 80 (TWEEN® 80), D-α-Tocopherol polyethylene glycol 1000 succinate (TPGS), polyethylene-polypropylene glycol (poloxamer 188), polyethylene-polypropylene glycol (poloxamer 407), polyvinyl pyrrolidone (Kollidon 30), polyvinyl pyrrolidone (Kollidon 90), Iota Carrageenan, Xanthan gum, locust Bean gum, Kelcogel LT100, acacia gum, guar gum, gamma-Cyclodextrin, Tracacanth gum, hydroxypropyl methylcellulose (HPMC), carboxymethyl cellulose (CMC), microcrystalline cellulose (MCC), lecithin, or a combination thereof.

In other embodiments, the surfactant is selected from: Lauroyl macrogol 32 glycerides (GELUCIRE® 44/14), polyethylene glycol 400 (PEG 400), propylene glycol laurate (Lauroglycol FCC), polysorbate 20 (TWEEN® 20), polysorbate 40 (TWEEN® 40), polysorbate 60 (TWEEN® 60), polysorbate 80 (TWEEN® 80), D-α-Tocopherol polyethylene glycol 1000 succinate (TPGS), polyethylene-polypropylene glycol (poloxamer 188), polyethylene-polypropylene glycol (poloxamer 407), polyvinyl pyrrolidone (Kollidon 30), polyvinyl pyrrolidone (Kollidon 90), Iota Carrageenan, Xanthan gum, locust Bean gum, Kelcogel LT100, acacia gum, guar gum, gamma-Cyclodextrin, Tracacanth gum, hydroxypropyl methylcellulose (HPMC), carboxymethyl cellulose (CMC), microcrystalline cellulose (MCC), lecithin, or a combination thereof.

In further embodiments, the surfactant is selected from: Lauroyl macrogol 32 glycerides (GELUCIRE® 44/14), polyethylene glycol 400 (PEG 400), propylene glycol laurate (Lauroglycol FCC), polysorbate 20 (TWEEN® 20), polysorbate 40 (TWEEN® 40), polysorbate 60 (TWEEN® 60), polysorbate 80 (TWEEN® 80), D-α-Tocopherol polyethylene glycol 1000 succinate (TPGS), polyethylene-polypropylene glycol (poloxamer 188), polyethylene-polypropylene glycol (poloxamer 407), polyvinyl pyrrolidone (Kollidon 30), polyvinyl pyrrolidone (Kollidon 90), or a combination thereof.

In a further embodiment, the surfactant is TPGS and/or lauroyl macrogol 32 glycerides (e.g., GELUCIRE® 44/14). In another further embodiment, the surfactant is polysorbate 80.

In some embodiments, the composition comprises at least one active ingredient, e.g., cannabinoid or cannabinoid extract and a surfactant in an amount selected from: at least 5 wt %, at least 10 wt %, at least 15 wt %, at least 20 wt %, at least 25 wt %, at least 30 wt %, at least 35 wt %, at least 40 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, or at least 97 wt % surfactant. In one embodiment, the active ingredient is selected from a cannabinoid, cannabinoid extract, terpene, terpene extract, or combinations thereof.

In some embodiments, the composition comprises at least one active ingredient, e.g., cannabinoid or cannabinoid extract, and a surfactant in an amount selected from: 0-2.5 wt %, 2.5-5 wt %, 5-10 wt %, 10-15 wt %, 15-20 wt %, 20-25 wt %, 25-30 wt %, 30-35 wt %, 35-40 wt %, 40-45 wt %, 45-50 wt %, 50-55 wt %, 55-60 wt %, 60-65 wt %, 65-70 wt %, 70-75 wt %, 75-80 wt %, 80-85 wt %, 85-90 wt %, 90-95 wt %, or 95-97 wt % surfactant. In one embodiment, the active ingredient is selected from a cannabinoid, cannabinoid extract, terpene, terpene extract, or combinations thereof.

In some embodiments, the composition comprises at least one active ingredient, e.g., cannabinoid or cannabinoid extract, and at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, or at least 97 wt % surfactant, wherein the surfactant has an HLB value greater than 9, greater than 10, between 9-17, between 9-16.7, between 9-16, between 9-15, between 10-17, between 10-16.7, between 10-16, between 10-15, between 10-14, between 9-13.4, between 14-16, between 14-17, between 15-17, or between 10-13.4. In a preferred embodiment, the surfactant has an HLB value of between 14-16. In a further preferred embodiment, the surfactant has an HLB value of about 15. In one embodiment, the active ingredient is selected from a cannabinoid, cannabinoid extract, terpene, terpene extract, or combinations thereof.

In another embodiment, the composition comprises at least one active ingredient, e.g., cannabinoid or cannabinoid extract, and at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, or at least 97 wt % surfactant, wherein the surfactant has an HLB value greater than 9, greater than 10, greater than 11.2, greater than 12, greater than 12.4, greater than 12.6, greater than 13, greater than 13.3, between 9-17, between 9-16.7, between 9-16, between 10-17, between 10-16.7, between 10-16, between 14-16, between 14-17, between 15-17, or between 10-15. In a preferred embodiment, the surfactant has an HLB value of between 14-16. In a further preferred embodiment, the surfactant has an HLB value of about 15. In one embodiment, the active ingredient is selected from a cannabinoid, cannabinoid extract, terpene, terpene extract, or combinations thereof.

In another embodiment, the composition comprises at least one active ingredient, e.g., cannabinoid or cannabinoid extract, and at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, or at least 97 wt % surfactant, wherein the surfactant has an HLB value greater than 9, greater than 10, greater than 11, greater than 12, greater than 12.4, greater than 13, greater than 14, between 9-17, between 9-16.7, between 9-16, between 10-17, between 10-16.7, between 10-16, between 10-15, between 12.4-17, between 12.4-16.7, between 12.4-16, between 14-16, between 14-17, between 15-17. In a preferred embodiment, the surfactant has an HLB value of between 14-16. In a further preferred embodiment, the surfactant has an HLB value of about 15. In a further embodiment, the composition comprises greater than 90 wt % surfactant. In one embodiment the active ingredient is selected from a cannabinoid, cannabinoid extract, terpene, terpene extract, or combinations thereof.

In one embodiment, the composition comprises:

an at least one active ingredient;

a fatty acid, monoglyceride, diglyceride, triglyceride, or a combination thereof; and, optionally,

a surfactant.

In one embodiment, the at least one active ingredient is selected from a cannabinoid, cannabinoid extract, terpene, terpene extract, or combinations thereof.

In another embodiment, the composition comprises:

a cannabinoid or cannabinoid extract and a surfactant.

In another embodiment, the composition comprises:

an active ingredient;

a surfactant; and, optionally,

a fatty acid, monoglyceride, diglyceride, triglyceride, or a combination thereof.

In one embodiment, the at least one active ingredient is selected from a cannabinoid, cannabinoid extract, terpene, terpene extract, or combinations thereof.

In one embodiment, the fatty acid, monoglyceride, diglyceride, triglyceride, or a combination thereof is a fatty acid. In another embodiment, the fatty acid, monoglyceride, diglyceride, triglyceride, or a combination thereof is a monoglyceride. In another embodiment, the fatty acid, monoglyceride, diglyceride, triglyceride, or a combination thereof is a diglyceride. In another embodiment, the fatty acid, monoglyceride, diglyceride, triglyceride, or a combination thereof is a triglyceride. In other embodiments, the fatty acid, monoglyceride, diglyceride, triglyceride, or a combination thereof, is a combination of a: fatty acid and monoglyceride; fatty acid and diglyceride; fatty acid and triglyceride; monoglyceride and diglyceride; monoglyceride and triglyceride; diglyceride and triglyceride; fatty acid, monoglyceride, diglyceride, and triglyceride; or monoglyceride, diglyceride, and triglyceride.

In one embodiment, the fatty acid, monoglyceride, diglyceride, triglyceride, or a combination thereof is an oil. In a further embodiment, the oil is selected from anise oil, apricot kernel oil PEG-6 esters, apricot kernel oil, beeswax, borage oil, canola oil, castor oil, polyoxyl 35 castor oil, polyoxyl 40 hydrogenated castor oil, polyoxyl 40 castor oil, polyoxyl 60 hydrogenated castor oil, hydrogenated castor oil, polyoxyl 60 castor oil, cinnamon oil, clove oil, coconut oil fractioned, coconut oil, coconut oil-lecithin, coriander oil, corn oil PEG-6 esters, corn oil PEG-8 esters, corn oil, cottonseed oil hydrogenated, cottonseed oil, cottonseed oil, hydrogenated soybean oil, hydrogenated vegetable oils, kernel oil PEG-6 esters, kernel oil, lemon oil, mineral oil (light), mineral oil, neutral oil, nutmeg oil, olive oil PEG-6 esters, olive oil, orange oil, palm kernel oil PEG-6 esters, palm kernel oil, palm kernel oil/palm kernel oil hydrogenated, palm fruit oil, peanut oil PEG-6 esters, peanut oil, peppermint oil, poppy seed oil, safflower oil, soybean oil hydrogenated, soybean oil refined, soybean oil, sunflower oil, triisostearin PEG-6 esters, vegetable oil hydrogenated, vegetable oil PEG esters, vegetable oil, vegetable oils glyceride hydrogenated, or a mixture thereof.

In one embodiment, the fatty acid, monoglyceride, diglyceride, triglyceride, or a combination thereof is a fat. In another embodiment, the fatty acid, monoglyceride, diglyceride, triglyceride, or a combination thereof is exogenously added fatty acid, monoglyceride, diglyceride, triglyceride, or a combination thereof. The term “exogenously added”, as used herein, means other than any fatty acids, monoglycerides, diglycerides, triglycerides, or combinations thereof, that were originally present in a cannabis plant, or other plant extract, and remains in the extract, e.g., a cannabinoid extract, after the extraction/distillation process. For clarity, pressed cannabis/hemp seed oil added to a composition of the present invention is exogenously added. In one embodiment, the only exogenously added fatty acid, monoglyceride, diglyceride, triglyceride, or a combination thereof, is a flavoring oil. In a further embodiment, the flavoring oil is an essential oil. In a further embodiment, the essential oil is produced by distillation (e.g., steam distillation), solvent extraction (example, a hydrocarbon such as hexane or supercritical carbon dioxide), or by expression.

In one embodiment, the cannabinoid extract is essentially free of fatty acids, monoglycerides, diglycerides, or triglycerides. In a further embodiment, the cannabinoid extract is essentially free of fatty acids. In another embodiment, the cannabinoid extract is essentially free of monoglycerides. In another embodiment, the cannabinoid extract is essentially free of diglycerides. In another embodiment, the cannabinoid extract is essentially free of triglycerides. In another embodiment, the composition is essentially free of exogenously added fatty acids. In another embodiment, the composition is essentially free of exogenously added monoglycerides. In another embodiment, the composition is essentially free of exogenously added diglycerides. In another embodiment, the composition is essentially free of exogenously added triglycerides. In another embodiment, the composition is essentially free of exogenously added fats or oils.

In some embodiments, the composition comprises at least one active ingredient and at least 5 wt %, at least 10 wt %, at least 15 wt %, at least 20 wt %, at least 25 wt %, at least 30 wt %, at least 35 wt %, at least 40 wt %, at least 50 wt %, at least 55 wt %, at least 60 wt %, at least 65 wt %, at least 70 wt %, at least 75 wt %, at least 80 wt %, at least 85 wt %, at least 90 wt %, at least 91 wt %, at least 92 wt %, at least 93 wt %, at least 94 wt %, or at least 95 wt % of exogenously added fat, oil, or a combination thereof. In one embodiment, the at least one active ingredient is selected from a cannabinoid, cannabinoid extract, terpene, terpene extract, or combinations thereof.

In some embodiments, the composition comprises at least one active ingredient and not more than 1 wt %, not more than 2 wt %, not more than 3 wt %, not more than 4 wt %, not more than 5 wt %, not more than 6 wt %, not more than 7 wt %, not more than 8 wt %, not more than 9 wt %, not more than 10 wt %, not more than 11 wt %, not more than 12 wt %, not more than 13 wt %, not more than 14 wt %, not more than 15 wt %, not more than 16 wt %, not more than 17 wt %, not more than 18 wt %, not more than 19 wt %, not more than 20 wt %, not more than 25 wt %, not more than 30 wt %, not more than 35 wt %, not more than 40 wt %, not more than 50 wt %, not more than 55 wt %, not more than 60 wt %, not more than 65 wt %, not more than 70 wt %, not more than 75 wt %, not more than 80 wt %, not more than 85 wt %, not more than 90 wt %, or not more than 95 wt % of exogenously added fat, oil, or a combination thereof, or a combination thereof. In one embodiment, the at least one active ingredient is selected from a cannabinoid, cannabinoid extract, terpene, terpene extract, or combinations thereof.

In some embodiments, the composition comprises at least one active ingredient and 0-2.5 wt %, 2.5-5 wt %, 5-10 wt %, 10-15 wt %, 15-20 wt %, 20-25 wt %, 25-30 wt %, 30-35 wt %, 35-40 wt %, 40-45 wt %, 45-50 wt %, 50-55 wt %, 55-60 wt %, 60-65 wt %, 65-70 wt %, 70-75 wt %, 75-80 wt %, 80-85 wt %, 85-90 wt %, 87-92 wt %, 90-95 wt %, or 91-96 wt % of exogenously added fat, oil, or a combination thereof, or a combination thereof. In one embodiment, the at least one active ingredient is selected from a cannabinoid, cannabinoid extract, terpene, terpene extract, or combinations thereof.

In some embodiments, the composition comprises at least one active ingredient and at least 5 wt %, at least 10 wt %, at least 15 wt %, at least 20 wt %, at least 25 wt %, at least 30 wt %, at least 35 wt %, at least 40 wt %, at least 50 wt %, at least 55 wt %, at least 60 wt %, at least 65 wt %, at least 70 wt %, at least 75 wt %, at least 80 wt %, at least 85 wt %, at least 90 wt %, at least 91 wt %, at least 92 wt %, at least 93 wt %, at least 94 wt %, or at least 95 wt % fatty acid, monoglyceride, diglyceride, triglyceride, or a combination thereof. In one embodiment, the at least one active ingredient is selected from a cannabinoid, cannabinoid extract, terpene, terpene extract, or combinations thereof.

In some embodiments, the composition comprises at least one active ingredient and not more than 1 wt %, not more than 2 wt %, not more than 3 wt %, not more than 4 wt %, not more than 5 wt %, not more than 6 wt %, not more than 7 wt %, not more than 8 wt %, not more than 9 wt %, not more than 10 wt %, not more than 11 wt %, not more than 12 wt %, not more than 13 wt %, not more than 14 wt %, not more than 15 wt %, not more than 16 wt %, not more than 17 wt %, not more than 18 wt %, not more than 19 wt %, not more than 20 wt %, not more than 25 wt %, not more than 30 wt %, not more than 35 wt %, not more than 40 wt %, not more than 50 wt %, not more than 55 wt %, not more than 60 wt %, not more than 65 wt %, not more than 70 wt %, not more than 75 wt %, not more than 80 wt %, not more than 85 wt %, not more than 90 wt %, or not more than 95 wt % fatty acid, monoglyceride, diglyceride, triglyceride, or a combination thereof. In one embodiment, the at least one active ingredient is selected from a cannabinoid, cannabinoid extract, terpene, terpene extract, or combinations thereof.

In some embodiments, the composition comprises at least one active ingredient and 0-2.5 wt %, 2.5-5 wt %, 5-10 wt %, 10-15 wt %, 15-20 wt %, 20-25 wt %, 25-30 wt %, 30-35 wt %, 35-40 wt %, 40-45 wt %, 45-50 wt %, 50-55 wt %, 55-60 wt %, 60-65 wt %, 65-70 wt %, 70-75 wt %, 75-80 wt %, 80-85 wt %, 85-90 wt %, 87-92 wt %, 90-95 wt %, or 91-96 wt % fatty acid, monoglyceride, diglyceride, triglyceride, or a combination thereof. In one embodiment, the at least one active ingredient is selected from a cannabinoid, cannabinoid extract, terpene, terpene extract, or combinations thereof.

In another embodiment, the monoglyceride, diglyceride, or triglyceride is a medium chain monoglyceride, diglyceride, or triglyceride and/or a long chain monoglyceride, diglyceride triglyceride. In a further embodiment, the triglyceride is a medium chain triglyceride (MCT). In another further embodiment, the triglyceride is a long chain triglyceride (LCT).

In one embodiment, the composition comprises: a cannabinoid, D-α-Tocopherol polyethylene glycol 1000 succinate (TPGS), and/or lauroyl macrogol 32 glycerides. In a further embodiment, the composition comprises a cannabinoid, TPGS, lauroyl macrogol 32 glycerides, and a MCT and/or LCT. In a further embodiment, the composition comprises a cannabinoid, TPGS, lauroyl macrogol 32 glycerides, and a MCT. In a further embodiment, the composition comprises a cannabinoid, TPGS, lauroyl macrogol 32 glycerides, and a LCT. In one embodiment, the lauroyl macrogol 32 glycerides is GELUCIRE 44/14.

In another embodiment, the composition comprises at least one active ingredient, and polysorbate 80. In one embodiment, the at least one active ingredient is selected from a cannabinoid, cannabinoid extract, terpene, terpene extract, or combinations thereof.

In a further embodiment, the composition consists of at least one active ingredient, and polysorbate 80. In one embodiment, the at least one active ingredient is selected from a cannabinoid, cannabinoid extract, terpene, terpene extract, or combinations thereof.

In a further embodiment, the composition comprises at least one active ingredient, polysorbate 80 and a MCT and/or LCT. In one embodiment, the at least one active ingredient is selected from a cannabinoid, cannabinoid extract, terpene, terpene extract, or combinations thereof.

In a further embodiment, the composition comprises at least one active ingredient, polysorbate 80 and an MCT. In a further embodiment, the composition comprises at least one active ingredient, polysorbate 80 and an LCT. In one embodiment, the at least one active ingredient is selected from a cannabinoid, cannabinoid extract, terpene, terpene extract, or combinations thereof.

In another embodiment, the composition comprises at least one active ingredient;

a MCT and/or LCT;

a first surfactant; and

a second surfactant;

wherein the wt % of said at least one active ingredient, MCT and/or LCT, first surfactant, and second surfactant is selected from one of the compositions in Table 1 below. Each of the composition in Table 1 is an individual embodiment of the present invention.

TABLE 1

| | Active | MCT | First | |
|---|---|---|---|---|
| | ingredient | and/or LCT | surfactant | Second surfactant |
| Composition # | wt % | wt % | wt % | wt % |
| 1 | 1-15 | 0-85 | 5-85 | 5-85 |
| 2 | 1-15 | 65-75 | 0-15 | 0-15 |
| 3 | 1-15 | 75-90 | 0-15 | 0-15 |
| 4 | 1-15 | 50-65 | 5-15 | 5-15 |
| 5 | 1-15 | 65-85 | 5-15 | 5-15 |
| 6 | 1-15 | 65-85 | 6-12 | 6-12 |
| 7 | 8-12 | 68-76 | 7-11 | 7-11 |
| 8 | 9-11 | 70-74 | 8-10 | 8-10 |
| 9 | 10 | 72 | 9 | 9 |
| 10 | 1-15 | 25-40 | 5-25 | 5-25 |
| 11 | 1-15 | 40-85 | 5-25 | 5-25 |
| 12 | 1-15 | 25-40 | 15-25 | 15-25 |
| 13 | 1-15 | 40-65 | 15-25 | 15-25 |
| 14 | 1-15 | 20-35 | 20-25 | 20-25 |
| 15 | 1-15 | 35-60 | 20-25 | 20-25 |
| 16 | 8-15 | 40-45 | 20-25 | 20-25 |
| 17 | 1-15 | 35-75 | 10-35 | 10-35 |
| 18 | 1-15 | 5-25 | 25-35 | 25-35 |
| 19 | 1-15 | 25-45 | 25-35 | 25-35 |
| 20 | 1-15 | 0-5 | 35-45 | 35-45 |
| 21 | 1-15 | 5-25 | 35-45 | 35-45 |
| 22 | 1-15 | <25 | 35-45 | 35-45 |
| 23 | 1-15 | <20 | 35-45 | 35-45 |
| 24 | 1-15 | <15 | 35-45 | 35-45 |
| 25 | 1-15 | <10 | 35-45 | 35-45 |
| 26 | 1-15 | <5 | 35-45 | 35-45 |
| 27 | 1-15 | <2.5 | 35-45 | 35-45 |
| 28 | 1-15 | 0-5 | 45-50 | 45-50 |
| 29 | 1-15 | 0-10 | 50-60 | 25-45 |
| 30 | 1-15 | 10-20 | 50-60 | 25-45 |
| 31 | 1-15 | 0-10 | 60-70 | 15-35 |
| 32 | 1-15 | 10-20 | 60-70 | 15-35 |
| 33 | 1-15 | 35-65 | 15-35 | 15-35 |
| 34 | 1-15 | 35-65 | 15-30 | 15-30 |
| 35 | 1-15 | 0-10 | 70-80 | 5-25 |
| 36 | 1-15 | 10-20 | 70-80 | 5-25 |
| 37 | 1-15 | 0-5 | 80-90 | 0-15 |
| 38 | 1-15 | 5-15 | 80-90 | 0-15 |
| 39 | 1-15 | 0-2.5 | 90-95 | 0-5 |
| 40 | 1-15 | 2.5-5 | 90-95 | 0-5 |
| 41 | 1-15 | 0-10 | 25-45 | 50-60 |
| 42 | 1-15 | 10-20 | 25-45 | 50-60 |
| 43 | 1-15 | 0-10 | 15-35 | 60-70 |
| 44 | 1-15 | 10-20 | 15-35 | 60-70 |
| 45 | 1-15 | 0-10 | 5-25 | 70-80 |
| 46 | 1-15 | 5-20 | 5-25 | 70-80 |
| 47 | 1-15 | 0-5 | 0-15 | 80-90 |
| 48 | 1-15 | 5-15 | 0-15 | 80-90 |
| 49 | 1-15 | 0-2.5 | 0-5 | 90-95 |
| 50 | 1-15 | 2.5-5 | 0-5 | 90-95 |
| 51 | 1-15 | 0-85 | 5-85 | 5-85 |
| 52 | 1-15 | 0-75 | 10-85 | 10-85 |
| 53 | 1-15 | 0-65 | 15-85 | 15-85 |
| 54 | 1-15 | 0-55 | 20-85 | 20-85 |
| 55 | 1-15 | 0-45 | 25-85 | 25-85 |
| 56 | 1-15 | 0-35 | 30-85 | 30-85 |
| 57 | 1-15 | 0-25 | 35-85 | 35-85 |
| 58 | 1-15 | 0-15 | 40-85 | 40-85 |
| 59 | 1-15 | 0-10 | 42.5-85 | 42.5-85 |
| 60 | 1-15 | 0-5 | 45-85 | 45-85 |
| 61 | 1-15 | 0-5 | 50-85 | 45-85 |
| 62 | 1-15 | 0-10 | 55-85 | 40-85 |
| 63 | 1-15 | 0-10 | 60-85 | 35-85 |
| 64 | 1-15 | 0-10 | 65-85 | 30-85 |
| 65 | 1-15 | 0-10 | 70-85 | 25-85 |
| 66 | 1-15 | 0-10 | 75-85 | 15-85 |
| 67 | 1-15 | 0-10 | 45-85 | 50-85 |
| 68 | 1-15 | 0-10 | 40-85 | 55-85 |
| 69 | 1-15 | 0-10 | 35-85 | 60-85 |
| 70 | 1-15 | 0-10 | 30-85 | 65-85 |
| 71 | 1-15 | 0-10 | 25-85 | 70-85 |
| 72 | 1-15 | 0-10 | 15-85 | 75-85 |
| 73 | 1-15 | 0-10 | 10-85 | 10-85 |
| 74 | 1-15 | 10-20 | 10-85 | 10-85 |
| 75 | 1-15 | 20-30 | 10-85 | 10-85 |
| 76 | 1-15 | 30-40 | 10-85 | 10-85 |
| 77 | 1-15 | 40-50 | 10-85 | 10-85 |
| 78 | 1-15 | 50-60 | 10-85 | 10-85 |
| 79 | 1-15 | 60-75 | 10-85 | 10-85 |
| 80 | 1-15 | 0-65 | 10-65 | 10-65 |
| 81 | 1-15 | 0-15 | 10-65 | 10-65 |
| 82 | 1-15 | 15-30 | 10-65 | 10-65 |
| 83 | 1-15 | 30-45 | 10-65 | 10-65 |
| 84 | 1-15 | 45-60 | 10-65 | 10-65 |
| 85 | 1-15 | 0-55 | 10-55 | 10-55 |
| 86 | 1-15 | 0-15 | 10-55 | 10-55 |
| 87 | 1-15 | 15-30 | 10-55 | 10-55 |
| 88 | 1-15 | 30-45 | 10-55 | 10-55 |
| 89 | 1-15 | 45-55 | 10-55 | 10-55 |
| 90 | 1-15 | 0-55 | 10-35 | 10-35 |
| 91 | 1-15 | 0-15 | 10-35 | 10-35 |
| 92 | 1-15 | 15-30 | 10-35 | 10-35 |
| 93 | 1-15 | 30-45 | 10-35 | 10-35 |
| 94 | 1-15 | 30-60 | 10-35 | 10-35 |
| 95 | 1-15 | 0-25 | 10-50 | 10-50 |
| 96 | 1-15 | 0-15 | 10-50 | 10-50 |
| 97 | 1-15 | 15-25 | 10-50 | 10-50 |
| 98 | 1-15 | 30-60 | 10-35 | 10-35 |
| 99 | 1-15 | 35-55 | 15-30 | 15-30 |
| 100 | 1-15 | 0-25 | 15-50 | 15-50 |
| 101 | 1-15 | 0-10 | 15-50 | 15-50 |
| 102 | 1-15 | 15-25 | 15-50 | 15-50 |
| 103 | 1-15 | 0-10 | 15-50 | 15-50 |
| 104 | 15-25 | 0-10 | 15-50 | 15-50 |
| 105 | 25-35 | 0-10 | 15-50 | 15-50 |
| 106 | 35-50 | 0-10 | 15-50 | 15-50 |

In further embodiments, the active ingredient of any one composition selected from 1-106 of Table 1 is a cannabinoid, cannabinoid extract, terpene, terpene extract, or combinations thereof. In further embodiments, the active ingredient is a cannabinoid. In further embodiments, the active ingredient is a cannabinoid extract. In further embodiments, the active ingredient is a terpene. In further embodiments, the active ingredient is a terpene extract.

In further embodiments, a composition selected from one of the compositions 1-106 of Table 1 is a non-aqueous composition.

In further embodiments, a composition selected from one of the compositions 1-106 of Table 1 is a solid or semi-solid composition.

In further embodiments, a composition selected from one of the compositions from 1-106 of Table 1 comprises: 1-3 wt %, 3-8 wt %, 5-10 wt %, 8-15 wt %, 8-12 wt %, 9-11 wt %, more than 8 wt %, more than 10 wt %, or 10-15 wt % of one or more active ingredient, preferably a cannabinoid or cannabinoid extract. In further embodiments, a composition selected from one of the compositions from 1-6, 10-15, and 17-103 of Table 1 comprises 1-5 wt % of one or more active ingredient, preferably a cannabinoid or cannabinoid extract.

In further embodiments, the cannabinoid extract comprises total cannabinoid(s) in an amount selected from: 50-75 wt %, 50-99 wt %, 75-99 wt %, 75-95 wt %, 80-99 wt %, 85-99 wt %, 90-99 wt %, 85-95 wt %, 90-95 wt %, or >99 wt % total cannabinoid(s).

In further embodiments, the total concentration of the one or more active ingredient, e.g., cannabinoid(s), in a composition selected from one of the compositions from 1-106 of Table 1 is 1-200 mg/mL. In further embodiments, the total concentration of the one or more active ingredient, e.g., cannabinoid(s), in a composition selected from 1-106 of Table 1 is selected from: 1-5 mg/mL, 1-10 mg/mL, 1-50 mg/mL, 1-100 mg/mL, 5-50 mg/mL, 10-50 mg/mL, 10-100 mg/mL, 5-10 mg/mL, 10-15 mg/mL, 15-20 mg/mL, 20-30 mg/mL, 30-40 mg/mL, 40-50 mg/mL, 50-75 mg/mL, 75-100 mg/mL, 100-150 mg/mL, or 150-200 mg/mL. In another embodiment, the total concentration of the active ingredient, e.g., cannabinoid(s), in a composition selected from one of the compositions from 1-106 of Table 1 is <0.001 mg/mL, 0.001-0.01 mg/mL, or 0.01-1 mg/mL.

In further embodiments, a composition selected from 1-106 of Table 1 comprises one or more active ingredient, e.g., cannabinoid(s), in an amount selected from: 0.25-1 mg, 0.5-2.5 mg, 2.5-5 mg, 5-7.5 mg, 7.5-10 mg, 10-12.5 mg, 12.5-15 mg, 15-20 mg, 20-30 mg, 30-40 mg, 40-50 mg, 50-60 mg, 60-70 mg, or 70-75 mg. In further embodiments, the cannabinoid is THC. In other embodiments, the cannabinoids are THC and CBD. In another embodiment, a composition selected from 1-106 of Table 1 comprises <0.001 mg, 0.001-0.25 mg, or 0.25-1 mg of cannabinoid(s).

In further embodiments, a composition selected from compositions 1-106 of Table 1 comprises MCT. In further embodiments, the composition comprises MCT, but not LCT. In further embodiments, the MCT is an oil. In further embodiments, where permissible based on the ranges for a particular composition, a composition of Table 1 comprises no more than 5 wt % MCT, 3 wt % MCT, or 1 wt % MCT. In further embodiments, a composition selected from compositions 1-106 comprises LCT. In further embodiments, the composition comprises LCT but not MCT. In further embodiments, the LCT is an oil. In further embodiments, where permissible based on the ranges for a particular composition, a composition of Table 1 comprises no more than 5 wt % LCT, 3 wt % LCT, or 1 wt % LCT. In further embodiments, the composition comprises both MCT and LCT. In further embodiments, both the MCT and the LCT is an oil.

In further embodiments, the first surfactant of a composition selected from 1-106 of Table 1 is D-α-Tocopherol polyethylene glycol 1000 succinate (TPGS). In further embodiments, the second surfactant of a composition selected from one of the compositions 1-106 of Table 1 is lauroyl macrogol 32 glycerides. In further embodiments, for a composition selected from 1-106 of Table 1, the first surfactant is D-α-Tocopherol polyethylene glycol 1000 succinate (TPGS) and the second surfactant is lauroyl macrogol 32 glycerides. In further embodiments, the lauroyl macrogol 32 glycerides is GELUCIRE 44/14.

In another embodiment, the invention provides a composition comprising:

at least one active ingredient; and

polysorbate 80 (polyoxyethylene (20) sorbitan monooleate, E433).

In one embodiment, the at least one active ingredient is selected from a cannabinoid, cannabinoid extract, terpene, terpene extract, or combinations thereof. In a further embodiment, the at least one active ingredient is selected from a cannabinoid or cannabinoid extract. In a further embodiment, the composition further comprises a medium-chain triglyceride (MCT) or long-chain triglyceride (LCT). In a further embodiment, the MCT or LCT is an oil.

In further embodiments, the composition comprises:

at least one active ingredient;

a surfactant; and, optionally,

a MCT and/or a LCT;

wherein the wt % of the at least one active ingredient, the surfactant, and the MCT and/or LCT is selected from one of the compositions in Table 2 below. Each of the compositions in Table 2 is an individual embodiment of the present invention.

TABLE 2

| | Active | MCT | | |
|---|---|---|---|---|
| Composition | ingredient wt % | wt % | LCT wt % | Surfactant wt % |
| 107 | 1-15 | 45-55 | 0-10 | 10-20 |
| 108 | 1-15 | 55-65 | 0-10 | 10-20 |
| 109 | 1-15 | 65-85 | 0-10 | 10-20 |
| 110 | 1-15 | 35-45 | 0-10 | 20-30 |
| 111 | 1-15 | 45-55 | 0-10 | 20-30 |
| 112 | 1-15 | 55-75 | 0-10 | 20-30 |
| 113 | 1-15 | 25-35 | 0-10 | 30-40 |
| 114 | 1-15 | 35-45 | 0-10 | 30-40 |
| 115 | 1-15 | 45-65 | 0-10 | 30-40 |
| 116 | 1-15 | 20-35 | 0-10 | 35-45 |
| 117 | 1-15 | 35-60 | 0-10 | 35-45 |
| 118 | 1-15 | 15-25 | 0-10 | 40-50 |
| 119 | 1-15 | 25-35 | 0-10 | 40-50 |
| 120 | 1-15 | 30-40 | 0-10 | 40-50 |
| 121 | 1-15 | 40-50 | 0-10 | 40-50 |
| 122 | 1-15 | 35-55 | 0-10 | 40-50 |
| 123 | 1-15 | 5-20 | 0-10 | 50-60 |
| 124 | 1-15 | 15-30 | 0-10 | 50-60 |
| 125 | 1-15 | 20-30 | 0-10 | 50-60 |
| 126 | 1-15 | 30-45 | 0-10 | 50-60 |
| 127 | 1-15 | 0-10 | 0-10 | 60-70 |
| 128 | 1-15 | 5-15 | 0-10 | 60-70 |
| 129 | 1-15 | 10-20 | 0-10 | 60-70 |
| 130 | 1-15 | 15-35 | 0-10 | 60-70 |
| 131 | 1-15 | 20-35 | 0-10 | 60-70 |
| 132 | 1-15 | 0-10 | 0-10 | 65-75 |
| 133 | 1-15 | 10-20 | 0-10 | 65-75 |
| 134 | 1-15 | 0-10 | 0-5 | 70-80 |
| 135 | 1-15 | 0-10 | 0-10 | 70-80 |
| 136 | 1-15 | 5-15 | 0-10 | 70-80 |
| 137 | 1-15 | 15-25 | 0-10 | 70-80 |
| 138 | 1-15 | 0-10 | 0-5 | 80-90 |
| 139 | 1-15 | 0-10 | 0-10 | 80-90 |
| 140 | 1-15 | 5-10 | 0-10 | 80-90 |
| 141 | 1-15 | 10-15 | 0-10 | 80-90 |
| 142 | 1-15 | 0-10 | 0-5 | 85-95 |
| 143 | 1-15 | 5-10 | 0-10 | 85-95 |
| 144 | 1-15 | 0-10 | 0-10 | 25-95 |
| 145 | 1-15 | 10-45 | 0-10 | 25-95 |
| 146 | 1-15 | 45-90 | 0-10 | 25-95 |
| 147 | 1-15 | 0-10 | 0-10 | 25-75 |
| 148 | 1-15 | 10-35 | 0-10 | 25-75 |
| 149 | 1-15 | 35-70 | 0-10 | 25-75 |
| 150 | 1-15 | 0-10 | 0-10 | 25-55 |
| 151 | 1-15 | 10-25 | 0-10 | 25-55 |
| 152 | 1-15 | 25-35 | 0-10 | 25-55 |
| 153 | 1-15 | 35-55 | 0-10 | 25-55 |
| 154 | 1-15 | 0-10 | 0-10 | 50-75 |
| 155 | 1-15 | 10-20 | 0-10 | 50-75 |
| 156 | 1-15 | 20-35 | 0-10 | 50-75 |
| 157 | 1-15 | 35-75 | 0-10 | 50-75 |
| 158 | 1-15 | 0-5 | 0-5 | 75-95 |
| 159 | 1-15 | 5-10 | 0-5 | 75-95 |
| 160 | 1-15 | 0-10 | 0-10 | 75-95 |
| 161 | 1-15 | 10-20 | 0-10 | 75-95 |
| 162 | 1-15 | 0-10 | 45-55 | 10-20 |
| 163 | 1-15 | 0-10 | 55-65 | 10-20 |
| 164 | 1-15 | 0-10 | 65-85 | 10-20 |
| 165 | 1-15 | 0-10 | 35-45 | 20-30 |
| 166 | 1-15 | 0-10 | 45-55 | 20-30 |
| 167 | 1-15 | 0-10 | 55-75 | 20-30 |
| 168 | 1-15 | 0-10 | 25-35 | 30-40 |
| 169 | 1-15 | 0-10 | 35-45 | 30-40 |
| 170 | 1-15 | 0-10 | 45-65 | 30-40 |
| 171 | 1-15 | 20-35 | 0-10 | 35-45 |
| 172 | 1-15 | 35-60 | 0-10 | 35-45 |
| 173 | 1-15 | 0-10 | 15-25 | 40-50 |
| 174 | 1-15 | 0-10 | 25-35 | 40-50 |
| 175 | 1-15 | 30-40 | 0-10 | 40-50 |
| 176 | 1-15 | 40-50 | 0-10 | 40-50 |
| 177 | 1-15 | 0-10 | 35-55 | 40-50 |
| 178 | 1-15 | 0-10 | 5-20 | 50-60 |
| 179 | 1-15 | 15-30 | 0-10 | 50-60 |
| 180 | 1-15 | 0-10 | 20-30 | 50-60 |
| 181 | 1-15 | 0-10 | 30-45 | 50-60 |
| 182 | 1-15 | 0-10 | 0-10 | 60-70 |
| 183 | 1-15 | 5-15 | 0-10 | 60-70 |
| 184 | 1-15 | 0-10 | 10-20 | 60-70 |
| 185 | 1-15 | 15-35 | 0-10 | 60-70 |
| 186 | 1-15 | 0-10 | 20-35 | 60-70 |
| 187 | 1-15 | 0-10 | 0-10 | 65-75 |
| 188 | 1-15 | 10-20 | 0-10 | 65-75 |
| 189 | 1-15 | 0-10 | 0-5 | 70-80 |
| 190 | 1-15 | 0-10 | 5-15 | 70-80 |
| 191 | 1-15 | 0-10 | 15-25 | 70-80 |
| 192 | 1-15 | 0-10 | 0-5 | 80-90 |
| 193 | 1-15 | 0-10 | 5-10 | 80-90 |
| 194 | 1-15 | 0-10 | 10-15 | 80-90 |
| 195 | 1-15 | 0-5 | 0-10 | 85-95 |
| 196 | 1-15 | 0-10 | 5-10 | 85-95 |
| 197 | 1-15 | 0-10 | 0-10 | 25-95 |
| 198 | 1-15 | 0-10 | 10-45 | 25-95 |
| 199 | 1-15 | 0-10 | 45-90 | 25-95 |
| 200 | 1-15 | 0-10 | 0-10 | 25-75 |
| 201 | 1-15 | 0-10 | 10-35 | 25-75 |
| 203 | 1-15 | 0-10 | 35-70 | 25-75 |
| 204 | 1-15 | 0-10 | 0-10 | 25-55 |
| 205 | 1-15 | 0-10 | 10-25 | 25-55 |
| 206 | 1-15 | 0-10 | 25-35 | 25-55 |
| 207 | 1-15 | 0-10 | 35-55 | 25-55 |
| 208 | 1-15 | 0-5 | 5-10 | 50-75 |
| 209 | 1-15 | 0-10 | 10-20 | 50-75 |
| 210 | 1-15 | 0-10 | 20-35 | 50-75 |
| 211 | 1-15 | 0-10 | 35-75 | 50-75 |
| 212 | 1-15 | 0-5 | 5-10 | 75-95 |
| 213 | 1-15 | 0-10 | 10-20 | 75-95 |
| 214 | 15-25 | 0-5 | 0-5 | 50-75 |
| 215 | 15-25 | 0-10 | 0-10 | 50-75 |
| 216 | 15-25 | 5-10 | 0-5 | 50-75 |
| 217 | 15-25 | 0-5 | 5-10 | 50-75 |
| 218 | 15-25 | 5-10 | 5-10 | 50-75 |
| 219 | 15-25 | 10-20 | 0-10 | 50-75 |
| 220 | 15-25 | 0-10 | 10-20 | 50-75 |
| 221 | 15-25 | 20-35 | 0-10 | 50-75 |
| 222 | 15-25 | 0-10 | 20-35 | 50-75 |
| 223 | 15-25 | 0-5 | 0-5 | 75-95 |
| 224 | 15-25 | 0-10 | 0-10 | 75-95 |
| 225 | 15-25 | 5-10 | 0-5 | 75-95 |
| 226 | 15-25 | 0-5 | 5-10 | 75-95 |
| 227 | 1-15 | 64-80 | | 8-28 |
| 228 | 1-15 | | 64-80 | 8-28 |
| 229 | 8-12 | 68-76 | | 14-22 |
| 230 | 8-12 | | 68-76 | 14-22 |
| 231 | 9-11 | 70-74 | | 16-20 |
| 232 | 9-11 | | 70-74 | 16-20 |
| 233 | 9-11 | 71-73 | | 17-19 |
| 234 | 9-11 | | 71-73 | 17-19 |
| 235 | 10 | 72 | | 18 |
| 236 | 10 | | 72 | 18 |
| 237 | 1-15 | 10-60 | | 35-75 |
| 238 | 1-15 | | 10-60 | 35-75 |
| 239 | 1-15 | 35-60 | | 35-55 |
| 240 | 1-15 | | 35-60 | 35-55 |
| 241 | 1-15 | 15-35 | | 60-70 |
| 242 | 1-15 | | 15-35 | 60-70 |
| 243 | 1-15 | 0-25 | | 70-80 |
| 244 | 1-15 | | 0-25 | 70-80 |
| 245 | 1-15 | 0-15 | | 70-80 |
| 246 | 1-15 | | 0-15 | 70-80 |
| 247 | 1-15 | 0-15 | | 80-90 |
| 248 | 1-15 | | 0-15 | 80-90 |
| 249 | 1-15 | 0-10 | | 85-95 |
| 250 | 1-15 | | 0-10 | 85-95 |
| 251 | 1-15 | 0-5 | | 85-95 |
| 252 | 1-15 | | 0-5 | 85-95 |
| 253 | 1-15 | 0 | | 85-95 |
| 254 | 1-15 | | 0 | 85-95 |
| 255 | 1-15 | 0 | 0 | 85-95 |

In further embodiments, the at least one active ingredient of any one composition selected from 107-255 of Table 2 is a cannabinoid, cannabinoid extract, terpene, terpene extract, or combinations thereof. In further embodiments, the active ingredient is a cannabinoid. In further embodiments, the active ingredient is a cannabinoid extract. In further embodiments, the active ingredient is a terpene. In further embodiments, the active ingredient is a terpene extract.

In further embodiments, a composition selected from one of the compositions from 107-255 of Table 2 is a non-aqueous composition.

In further embodiments, a composition selected from one of the compositions from 107-255 of Table 2 is a solid or semi-solid composition.

In further embodiments, a composition selected from one of the compositions from 107-255 of Table 2 comprises: 8-15 wt %, 8-12 wt %, 9-11 wt %, more than 8 wt %, more than 10 wt %, or 10-15 wt % of an active ingredient, e.g., a cannabinoid or cannabinoid extract. In further embodiments, a composition selected from one of the compositions from 1-213, 227, 228, and 237-255 of Table 2 comprises 1-5 wt % or 3-8% of an active ingredient, e.g., a cannabinoid or cannabinoid extract.

In further embodiments, the cannabinoid extract comprises a cannabinoid(s) in an amount selected from: 50-75 wt %, 50-99 wt %, 75-99 wt %, 75-95 wt %, 80-99 wt %, 85-99 wt %, 90-99 wt %, 85-95 wt %, 90-95 wt %, or >99 wt % cannabinoids.

In further embodiments, the total concentration of the at least one active ingredient, e.g., cannabinoid(s), in a composition selected from 107-255 of Table 2 is 1-200 mg/mL. In further embodiments, the total concentration of the active ingredient, e.g., cannabinoid(s), in a composition selected from 107-255 of Table 2 is selected from: 1-5 mg/mL, 1-10 mg/mL, 1-50 mg/mL, 1-100 mg/mL, 5-50 mg/mL, 10-50 mg/mL, 10-100 mg/mL, 5-10 mg/mL, 10-15 mg/mL, 15-20 mg/mL, 20-30 mg/mL, 30-40 mg/mL, 40-50 mg/mL, 50-75 mg/mL, 75-100 mg/mL, 100-150 mg/mL, or 150-200 mg/mL. In another embodiment, the total concentration of the at least one active ingredient, e.g., cannabinoid(s), in a composition selected from one of the compositions from 107-255 of Table 2 is <0.001 mg/mL, 0.001-0.01 mg/mL, or 0.01-1 mg/mL.

In further embodiments, a composition selected from one of the compositions from 107-255 of Table 2 contains the at least one active ingredient, e.g., cannabinoid(s), in an amount selected from: 0.25-1 mg, 0.5-2.5 mg, 2.5-5 mg, 5-7.5 mg, 7.5-10 mg, 10-12.5 mg, 12.5-15 mg, 15-20 mg, 20-30 mg, 30-40 mg, 40-50 mg, 50-60 mg, 60-70 mg, or 70-75 mg. In further embodiments, the cannabinoid is THC. In other embodiments, the cannabinoids are THC and CBD. In another embodiment, a composition selected from 107-255 of Table 2 comprises <0.001 mg, 0.001-0.25 mg, or 0.25-1 mg.

In further embodiments, the surfactant in a composition selected from compositions 107-255 of Table 2 is polysorbate 80. In further embodiments, the surfactant in a composition selected from compositions 107-255 of Table 2 is polyoxyethylene (10) oleyl ether (e.g., BRIJ 010). In further embodiments, the surfactant in a composition selected from compositions 107-255 of Table 2 is macrogol 15 hydroxystearate (e.g., Solutol HS 15).

In further embodiments, where permissible based on the ranges for a particular formula, a composition of Table 2 comprises no more than 5 wt % MCT, 3 wt % MCT, or 1 wt % MCT. In further embodiments, the MCT is an oil. In further embodiments, the composition comprises no MCT. In further embodiments, where permissible based on the ranges for a particular formula, a composition of Table 2 comprises no more than 5 wt % LCT, 3 wt % LCT, or 1 wt % LCT. In further embodiments, the LCT is an oil. In further embodiments, the composition comprises no LCT. In further embodiments, the composition comprises both MCT and LCT. In further embodiments, both the MCT and the LCT is an oil.

The medium chain triglycerides (MCT) of the present invention are triglycerides whose fatty acids have an aliphatic tail of 6-12 carbon atoms. In one embodiment, the MCT is formed from fatty acids having from C6 to C8, C8 to C10, C10 to C12, or C8 to C12 carbon atoms. The fatty acids of the MCT may be saturated, mono-unsaturated, and/or poly-unsaturated fatty acids. In one embodiment 80 to 100% of the medium chain fatty acids are saturated, 0 to 10% are monounsaturated, and 0 to 5% are polyunsaturated. Preferred medium chain fatty acids include caproic acid, caprylic acid, capric acid, and mixtures thereof. An oil comprising MCT, may comprise at least 5 wt % medium chain triglycerides, e.g., coconut oil, or palm kernel oil. In one embodiment, the oil comprising an MCT is coconut oil. MCT may be in the form of oil that is enriched or fractionated to increase the concentration of medium chain triglycerides. In one embodiment, the MCT is fractionated coconut oil (e.g., glyceryl tricaprylate or NATURE′S OIL MCT). Medium chain triglycerides may also be formed by esterifying glycerol with mixtures of C6-C12 fatty acids, e.g., C8-C10 fatty acids such as caprylic (C:8) and capric (C:10) fatty acids fractionated from coconut or palm kernel oils.

The long chain triglycerides (LCT) of the present invention are triglycerides whose fatty acids have an aliphatic tail of 13-24 carbon atoms. In one embodiment, the LCT is formed from long chain fatty having from C14 to C16, C16 to C18, C18 to C20, C14 to C20, or C20 to C24 carbon atoms. The fatty acids of the LCT may be saturated, mono-unsaturated, and poly-unsaturated fatty acids. In one embodiment 5 to 25% of the long chain fatty acids are saturated, 15 to 80% are monounsaturated, and 15 to 80% are polyunsaturated. The oil comprising an LCT may comprise at least 5 wt % long chain triglycerides, e.g., olive oil, poppy seed, safflower, sunflower, corn, and soybean oils, sesame oil, or castor oil. LCT may be in the form of oil that is enriched or fractionated to increase the concentration of long chain triglycerides. In one embodiment, the LCT is olive oil.

The oil comprising an MCT and/or LCT may be selected from the group consisting of borage oil, castor oil, coconut oil, cottonseed oil, soybean oil, safflower oil, sunflower oil, castor oil, corn oil, olive oil, palm oil, peanut oil, poppy seed oil, canola oil, hydrogenated soybean oil, hydrogenated vegetable oils, sesame oil, triolein, trilinolein, and trilinolenin.

The compositions of the present invention are preferably for oral administration.

As used herein, “emulsion” refers to a colloidal dispersion of two immiscible liquids, for example, an oil and water (or other aqueous liquid, e.g., a polar solvent, simulated gastric fluid, gastric fluid, simulated intestinal fluid, intestinal fluid), one of which is part of a continuous phase and the other of which is part of a dispersed phase. Emulsions typically are stabilized by one or more surfactants and/or co-surfactants and/or emulsion stabilizers. Surfactants form an interfacial film between the oil and water phase of the emulsion, providing stability. Typically, emulsions contain micelles that contain one or more surfactants surrounding a non-polar compound which is dispersed in the water phase. In general, emulsions (e.g., oil-in-water emulsions) are colloidal dispersions of two immiscible liquids (e.g., an oil and an aqueous liquid, such as water) that contain a continuous and a dispersed phase. Emulsions can be used to disperse non-polar compounds in aqueous liquids. In an oil-in-water emulsion, the dispersed phase is an oil phase and the continuous phase is an aqueous (e.g., water) phase. Some of the compositions of the present invention self-emulsify in aqueous solutions, e.g., water, gastric fluids or intestinal fluids, to form an oil-in-water emulsion.

As used herein, “surfactant” refers to synthetic and naturally occurring amphiphilic molecules that have hydrophobic portion(s) and hydrophilic portion(s). Due to their amphiphilic (amphipathic) nature, surfactants typically can reduce the surface tension between two immiscible liquids, for example, the oil and water phases in an emulsion, stabilizing the emulsion. Surfactants can be characterized based on their relative hydrophobicity and/or hydrophilicity. For example, relatively lipophilic surfactants are more soluble in fats, oils and waxes, and typically have HLB values less than or about 10, while relatively hydrophilic surfactants are more soluble in aqueous compositions, for example, water, and typically have HLB values greater than or about 10. Relatively amphiphilic surfactants are soluble in oil- and water-based liquids and typically have HLB values close to 10 or about 10.

The “HLB” refers to a value that is used to index and describe a surfactant according to its relative hydrophobicity/hydrophilicity, relative to other surfactants. HLB number of a surfactant is defined as HLB=20*MH/MT, where MH and MT are the mass of the hydrophilic head group and the total surfactant mass, respectively. A surfactant's HLB value is an indication of the molecular balance of the hydrophobic and hydrophilic portions of the surfactant, which is an amphipathic molecule.

As used herein, “micelle” refers to aggregates formed by surfactants that typically form when a surfactant is present in an aqueous composition, typically when the surfactant is used at a concentration above the critical micelle concentration (CMC). In micelles, the hydrophilic portions of the surfactant molecules contact the aqueous or the water phase, while the hydrophobic portions form the core of the micelle, which can encapsulate non-polar ingredient(s), for example, a cannabinoid. Typically, the surfactants in the provided concentrates form micelles containing the non-polar ingredient at their center in the aqueous liquid dilution compositions.

In one embodiment, the composition of the present invention is self-emulsifying in an aqueous solution. In a further embodiment, the composition forms a micellar dispersion in an aqueous solution.

In another embodiment, the composition of the present invention further comprises an aqueous solution. In a further embodiment, the aqueous solution is selected from a polar solvent, water, simulated gastric fluid, gastric fluid, simulated intestinal fluid, or intestinal fluid. In another embodiment, the surfactant is at a concentration that is greater than its critical micelle concentration (CMC). In one embodiment, the composition is a micellar dispersion. In another embodiment, the composition is an emulsion. In a further embodiment, the emulsion is an oil-in-water emulsion.

In another embodiment, the invention provides for a beverage additive product comprising a composition of the present invention. For example, a beverage additive composition can contain one or more active ingredients, e.g., an active ingredient(s) derived from a cannabis plant, such as, one or more cannabinoid(s), terpene(s) or any other active ingredient of cannabis plant extract. The active ingredient(s) of the beverage additive can also be one or more cannabinoid(s), terpene(s) or any other active ingredient of cannabis plant extract that is/are derived synthetically. In addition to a surfactant, an optionally an oil, the beverage additive may further contain a flavoring agent, sweetener, or an edible carrier. The beverage additive may be provided in liquid, semi-solid, or solid form. The concentration of total active ingredients, e.g., cannabinoids, in the beverage additive may be selected from <0.001 mg/mL, 0.001-0.01 mg/mL, or 0.01-1 mg/mL, 1-5 mg/mL, 1-10 mg/mL, 1-50 mg/mL, 1-100 mg/mL, 5-50 mg/mL, 10-50 mg/mL, 10-100 mg/mL, 5-10 mg/mL, 10-15 mg/mL, 15-20 mg/mL, 20-30 mg/mL, 30-40 mg/mL, 40-50 mg/mL, 50-75 mg/mL, 75-100 mg/mL, 100-150 mg/mL, or 150-200 mg/mL. The total active ingredients, e.g., cannabinoids in the beverage additive may be selected from <0.001 mg, 0.001-0.25 mg, or 0.25-1 mg, 0.25-1 mg, 0.5-2.5 mg, 2.5-5 mg, 5-7.5 mg, 7.5-10 mg, 10-12.5 mg, 12.5-15 mg, 15-20 mg, 20-30 mg, 30-40 mg, 40-50 mg, 50-60 mg, 60-70 mg, or 70-75 mg. Prior to ingestion, the beverage additive can be added to water or any drink of choice. The dilution ratio of beverage additive:beverage will depend on the composition of the beverage additive and selection of beverage type. In one embodiment, the beverage additive is diluted from 1:1-10,000 (i.e., 1 part beverage additive to 1-10,000 parts beverage). In further embodiments, the ratio is 1:1,000-10,000, 1:750-1,000, 1:500-750, 1:250-500, 1:100-250, 1:75-100, 1:50-75, 1:25-50, 1:10-25, 1:7.5-10, 1:5-7.5, 1:2.5-5, 1:1-2.5, or 1:1. In another embodiment the ratio beverage additive to beverage is 1:0.5-1. In one embodiment, the beverage additive is added to a beverage to provide an aqueous emulsion. In one embodiment, the aqueous emulsion is transparent.

Depending on the composition, aqueous emulsification may require mechanical input, such as shaking, mixing or stirring. Depending on the composition, the organoleptic properties of the emulsion may vary. For example, high surfactant content beverage additives can form clear, transparent emulsions, while compositions containing oils can form more turbid, i.e., translucent or opaque emulsions. The taste or flavor of the emulsion can vary with the composition, such as the exact content of active ingredient(s), surfactant(s), oil(s), flavoring agent(s), sweetener(s) and edible carrier(s). Due to high “solvent capacity” or “dilutability” of some compositions presented in this invention, the emulsion can retain its desirable particle size distribution upon ingestion and dilution in the gut. This can provide pharmacokinetic benefits, such as faster onset of action, increased bioavailability and reduced pharmacokinetic variability, e.g., reduced dependence of pharmacokinetics on digestion, and reduced food effects.

The beverage additive may be added to any beverage suitable for human consumption. Examples include, water, milk, tea, coffee, fruit juice (e.g., orange, apple, cranberry, pear, currant, etc.), vegetable juice (e.g., carrot, tomato, etc.), and carbonated drinks (etc. sparkling water, soda water, sports drinks, and soft drinks such as colas). In one embodiment, the invention includes a combination of a beverage additive and a beverage or a kit comprising the beverage additive and the beverage, wherein the beverage additive and the beverage are in separate containers. In another embodiment, the beverage additive and the beverage are separate compartments of a container. For example, where the beverage additive is contained in a compartment in a cap/closure of a container. In another embodiment, the invention provides for a method of making a cannabis plant based beverage comprising a composition of the present invention, the method comprising the steps of: obtaining a beverage additive and a beverage; adding the beverage additive to the beverage; and mixing the combined beverage additive and beverage to form a cannabis plant based beverage. In a further embodiment, the combined beverage is homogeneous. In a further embodiment, the combined beverage is an emulsion.

In another embodiment, the invention provides for a beverage comprising the beverage additive. In some embodiments, the beverage is an aqueous beverage. In further embodiments, the aqueous beverage is selected from water, coffee, tea, fruit juice (e.g., orange, apple, cranberry, pear, pineapple, currant, etc.), algae (e.g., blue-green algae), vegetable juice (e.g., carrot, tomato, wheat or other grass, mixed vegetable or mixed vegetable-fruit etc.), sports drinks, and carbonated drinks (etc. sparkling water, soda water, and soft drinks such as colas). In other embodiments, the beverage is a dairy based beverage. In further embodiments, the dairy based beverage is selected from milk and yogurt drinks (including beverages that comprise milk or yogurt).

In one embodiment, the invention relates to a drinking straw for use with a beverage in a beverage container, wherein the drinking straw comprises a composition (e.g., cannabinoid composition) of the present invention (including a beverage additive). In some embodiments, the drinking straw comprises a compartment or an erodible surface within an interior portion of the straw that contains the composition of the present invention, e.g., cannabinoid composition. The straw may further comprise a one-way valve that prevents the composition of the present invention, e.g., cannabinoid composition from entering the beverage container. Examples of drinking straws of include those disclosed in United States patents U.S. Pat. Nos. 5,921,955, 8,342,422, 6,482,451, and U.S. Pat. No. 8,980,348; United States patent applications US 2012/0056008, US 2008/0181932, US 2004/0142958, and US 2009/0041904; and in PCT publication WO 2001/014220.

The term “particle size” refers herein to oil in water droplet diameter, or water in oil droplet diameter, in an emulsion. The average particle size of the emulsion is in the range of about 50 nm to about 1000 nm, depending on the composition. In one embodiment, the average particle size is between 10-50 nm. In another embodiment, the average particle size is between 50-100 nm. In another embodiment, the average particle size is between 75-125 nm. In another embodiment, the average particle size is between 100-150 nm. In another embodiment, the average particle size is between 200-400 nm. In another embodiment, the average particle size is between 200-300 nm. In another embodiment, the average particle size is between 250-350 nm. In another embodiment, the average particle size is between 300-400 nm. In another embodiment, the average particle size is between 400-500 nm. In another embodiment, the average particle size is between 500-600 nm. In another embodiment, the average particle size is between 600-650 nm. In another embodiment, the average particle size is between 600-700 nm. In another embodiment, the average particle size is between 700-800 nm. In another embodiment, the average particle size is between 800-900 nm. In another embodiment, the average particle size is between 750-850 nm. In one embodiment, the average particle size is less than 500 nm. In another embodiment, the average particle size is less than 400 nm. In another embodiment, the average particle size is less than 300 nm. In another embodiment, the average particle size is less than 200 nm. In another embodiment, the average particle size is less than 150 nm. In another embodiment, the average particle size is less than 100 nm. In another embodiment, the average particle size is less than 50 nm.

The term “chemically stable” or “chemical stability” of a composition of the present invention refers to the ability of the composition and/or cannabinoid(s) in the composition to resist change in its chemical properties over time. Chemical instability of a composition may be manifested by decrease in the amount of the active ingredient, e.g., cannabinoid, e.g., THC or CBD. Chemical degradation of THC, e.g., may occur due to conversion of TCH to cannabinol (CBN). Chemical degradation of CBD, e.g., may occur due to oxidation, resulting in monomeric and dimeric hydroxyquinones. Physical instability of an emulsion may be manifested in any of the following: flocculation, creaming, coalescence and Ostwald ripening. Determination whether an emulsion has lost its physical stability may be carried out in any of the following techniques: measurement of particle size, light scattering, focused beam reflectance measurement, centrifugation, rheology or a combination thereof.

In one embodiment, the composition is stable at room temperature (21-25° C.), for a period of time that is at least about 12 months, for at least about 18 months, or for at least about 24 months, at 25° C. ±2° C./40% RH ±5% RH, with <20% decrease, <10% decrease, or preferably <5% decrease, in active ingredient content, e.g., in cannabinoid content, e.g., total, THC or CBD, and no change on dispersion in 37° C. water over the respective time period 12 months. It is also an object of the present invention to provide the composition as mentioned above, wherein the composition is stable at 5° C. ±3° C./40% RH ±5% RH for a period of time that is at least about 6 months, preferably for at least about 12 months, more preferably for at least about 18 months, more preferably for at least about 24 months, with <20% decrease, <10% decrease, or preferably <5% decrease, in active ingredient, e.g., in cannabinoid content, e.g., total, THC or CBD, and no change on dispersion in 37° C. water over the relevant time frame. It is also an object of the present invention to provide the composition as mentioned above, wherein the composition is stable at about 40° C. ±2° C./75% RH ±5% RH for a period of time that is at least about 2 months, preferably for at least about 6 months, more preferably for at least about 9 months, even more preferably for at least about 12 months, and most preferably for at least about 24 months, with <20% decrease, <10% decrease, or preferably <5% decrease, in active ingredient, e.g., in cannabinoid content and no change on dispersion in 37° C. water over the relevant respective time frame.

In a further embodiment, the composition is stable at room temperature (21-25° C.), for a period of time that is at least about 12 months, at 25° C. ±2° C./40% RH ±5% RH, with <20% decrease in active ingredient content, e.g., in cannabinoid content, e.g., total, THC or CBD, and no change on dispersion in 37° C. water over the period of time. In a further embodiment, the formulation is stable for at least about 18 months. In a further embodiment, the formulation is stable for at least about 24 months. In a further embodiment, there is <10% decrease in active ingredient content, e.g., in cannabinoid content, e.g., total, THC or CBD. In a further embodiment, there is <5% decrease in active ingredient content, e.g., in cannabinoid content, e.g., total, THC or CBD.

In a further embodiment, the composition is stable at 5° C. ±3° C./40% RH ±5% RH for a period of time that is at least about 6 months, with <20% decrease in active ingredient, e.g., in cannabinoid content, e.g., total, THC or CBD, and no change on dispersion in 37° C. water over the period of time. In a further embodiment, the formulation is stable for at least about 12 months. In a further embodiment, the formulation is stable for at least about 18 months. In a further embodiment, the formulation is stable for at least about 24 months. In a further embodiment, there is <10% decrease in active ingredient content, e.g., in cannabinoid content, e.g., total, THC or CBD. In a further embodiment, there is <5% decrease in active ingredient content, e.g., in cannabinoid content, e.g., total, THC or CBD.

In a further embodiment, the composition is stable at about 40° C. ±2° C./75% RH ±5% RH for a period of time that is at least about 2 months, with <20% decrease in active ingredient, e.g., in cannabinoid content and no change on dispersion in 37° C. water over the period of time. In a further embodiment, the formulation is stable for at least about 9 months. In a further embodiment, the formulation is stable for at least about 12 months. In a further embodiment, the formulation is stable for at least about 24 months. In a further embodiment, there is <10% decrease in active ingredient content, e.g., in cannabinoid content, e.g., total, THC or CBD. In a further embodiment, there is <5% decrease in active ingredient content, e.g., in cannabinoid content, e.g., total, THC or CBD.

Active ingredients of the present invention, e.g., cannabinoids and terpenes, may be purchased, synthesized using well-known techniques, or extracted from a plant using well-known methods. Terpenes, e.g., may be extracted from a plant of the Cannabis genus, e.g., Cannabis sativa, Cannabis indica, Cannabis hybrid, or other, or from a plant that is not a member of the Cannabis genus, e.g., is not from Cannabis sativa, Cannabis indica, Cannabis hybrid, or other Cannabis species. Phytocannabinoids and terpenes may be extracted as terpene blends or, in the case of a Cannabis species, as a cannabinoid or cannabinoid/terpene blend. The blends may be used directly or can be separated into individual or fewer components using distillation (e.g., short-path rotary distillation) or other techniques. The relative amount of each principal phytocannabinoid and/or terpene in the plant extract, e.g., cannabis extract, varies according to the cannabinoid and/or terpene profile and levels of the particular plants and methodology of extraction. Extracts comprising terpenes, e.g., extracts essentially free of cannabinoids, extracts that contain cannabinoids as a minor constituent, or extracts from a plant that is not a species of Cannabis (e.g., Cannabis sativa, Cannabis indica, Cannabis hybrid, or other), i.e., a non-Cannabis species, may be used individually or combined with one or more other active ingredients, e.g., cannabinoids or cannabinoid extracts.

Cannabinoids and/or terpenes may be obtained by separating resins from leaves or leaves and flowers of cannabis plants by solvent extraction. Extracts derived from cannabis plants include primary extracts prepared by such processes as, for example, maceration, percolation, and solvent extraction. Solvent extraction may be carried out using a solvent that dissolves cannabinoids/cannabinoid acids, such as for example C1 to C5 alcohols (e.g. ethanol, methanol), C3-C12 alkanes (e.g. hexane, butane or propane), Norflurane (HFA134a), HFA227, and carbon dioxide. General protocols for the preparation of extracts of cannabis plant material are described in US20060167283 (WO 02/064109), which is incorporated herein by reference. Carbon dioxide provides another method to extract cannabinoid/terpene resins from cannabis plant material. Sub Critical (Liquid) or Supercritical CO₂ is forced through the plant matter, which separates the cannabinoid/terpenes from the plant matter resulting in a transparent, amber oil. The extracts obtained by supercritical fluid extraction (SFE) may undergo a secondary extraction, e.g. an ethanolic precipitation, to remove non-cannabinoid/terpene materials. In a preferred embodiment, light petroleum gas extraction, using a LHBES (light hydrocarbon butane extraction system) 1300/C from Extractiontek Solutions is used to extract cannabinoids from cannabis plant material.

A modified extraction process consists of decarboxylating the starting concentrate at 300° F. until fully converted and the bubbling stops. Once the oil is decarboxylated, it is run through the VTA-VKL 70-5 short path rotary distillation plant twice. The first run separates the heavy terpenes and lighter terpenes from the cannabinoids and waste material. The cannabinoids and waste are run through again with a higher vacuum and higher temperature to separate the cannabinoids from the remaining waste. The waste is collected and run again in a larger batch to extract all cannabinoids and terpenes. The VTA-VKL 70-5 short path rotary distillation plant uses a top stirring rotary column to wipe incoming product into a thin film for better heat distribution and evaporation. The inner condensing column is set to condense the cannabinoids into liquids. The waste and cannabinoids are diverted into the two dispensing arms for collection into receiving vessels. The light terpenes are collected in a receiving flask attached to the inline chiller on the plant. The system (except for feed vessel) are under vacuum during the operation. The vacuum for the first run should be between 0.5-0.7 mbar. For the second run, pressure should be between 0.5-0.07 mbar.

The present invention includes a cannabinoid selected from the group consisting: of tetrahydrocannabinol, Δ9-tetrahydrocannabinol (THC), Δ8-tetrahydrocannabinol, a cannabis extract, tetrahydrocannabinolic acid (THCA), cannabidiolic acid (CBDA), Δ8-tetrahydrocannabinol-DMH, Δ9-tetrahydrocannabinol propyl analogue (THCV), 11-hydroxy-tetrahydrocannabinol, 11-nor-9-carboxy-tetrahydrocannabinol, 5′-azido-Δ8-tetrahydrocannabinol, AMG-1, AMG-3, AM411, AM708, AM836, AM855, AM919, AM926, AM938, cannabidiol (CBD), cannabivarin (CBV), tetrahydrocannabivarin (THCV), cannabidivarin (CBDV), cannabichromevarin (CBCV), cannabigerovarin (CBGV), cannabigerol monomethyl ether (CBGM),cannabidiol propyl analogue (CBDV), cannabinol (CBN), cannabichromene (CBC), cannabichromene propyl analogue, cannabigerol (CBG), cannabicyclol (CBL), cannabielsoin (CBE), cannabinodiol (CBDL), and cannabitriol (CBTL), CP 47497, CP 55940, CP 55244, CP 50556, CT-3 or IP-751 (ajulemic acid), dimethylheptyl HHC, HU-210, HU-211, HU-308, WIN 55212-2, desacetyl-L-nantradol, dexanabinol, JWH-051, JWH-133, levonantradol, L-759633, nabilone, O-1184, cannabicyclohexanol (CP-47,497 C8 homolog), 10-hydroxycannabidiol, 1′,2′,3′,4′,5′-pentanorcannabinol-3-carboxylic acid, 1′-hydroxycannabinol, 11-hydroxycannabinol, 9-carboxy-11-norcannabinol, 1′-oxocannabinol, 11-nor-Δ8-THC-9-carboxylic acid, T-carboxy-3′,4′,5′-trinor-Δ9-THC, 5′-carboxy-Δ9-THC, 9-carboxy-11-nor-Δ9-THC, 9-carboxy-11-nor-Δ8-THC, [(6aR,10aR)-3-[(1S,2R)-1,2-dimethylheptyl]-6a,7,10,10a-tetrahydro-6, 6,9-trimethyl-6H-dibenzo[b,d]pyran-1-ol], 9-carboxy-11-nor-(2 or 4)-chloro-Δ8-THC, 8α-11-dihydroxy-Δ9-THC, 8β-11-Dihydroxy-Δ9-THC, 5′-Dimethylamino-Δ8-THC, 11-hydroxy-Δ9-THC, 1′-hydroxy-Δ9-THC (Isomer B), 11-hydroxy-Δ8-THC, 2′-hydroxy-Δ9-THC, 3′-hydroxy-Δ9-THC, 4′-hydroxy-Δ9-THC, 5′-hydroxy-Δ9-THC, 8α-hydroxy-Δ9-THC, 8β-hydroxy-Δ9-THC, 5′-methylamino-Δ8-THC, 5′-N-methyl-N-4-(7-nitrobenzofurazano)amino-Δ8-THC, (−)-trans-Δ8-THC, 5′-trimethylammonium-Δ8-THC phenolate, 5′-Trimethylammonium-11-hydroxy-Δ8-THC phenolate, or a mixture thereof. In a preferred embodiment, the cannabinoid is selected from the group consisting of THC, CBD, THCA, CBDA, CBV, THCV, CBDV, CBCV, CBGV, CBN, CBC, and CBDL. In another embodiment, the cannabinoid is selected from the group consisting of THC, CBD, THCA, and CBDA. In another embodiment, the cannabinoid is THC or CBD. In another embodiment, the THC is Δ9-THC or Δ8-THC. In another embodiment, the THC is Δ9-THC.

In a preferred embodiment, the cannabinoid is in the form of aCannabis sativa, Cannabis indica, or Cannabis hybrid extract. In one embodiment, the cannabis extract comprises Δ9 THC. In another embodiment, the extract comprises CBD. In another embodiment, the cannabinoid is a synthetic cannabinoid, e.g., dronabinol.

In one embodiment, a composition of the present invention comprises: 1-5 wt %, 5-10 wt %, more than 5 wt %, 8-15 wt %, 8-12 wt %, more than 8 wt %, 9-11 wt %, more than 10 wt %, 10-15 wt %, 15-20 wt %, 20-30 wt %, 30-40 wt %, 40-50 wt %, of a cannabinoid or cannabinoid extract.

In one embodiment, the cannabinoid extract comprises 50-99 wt % cannabinoids. In another embodiment, the cannabinoid extract comprises >99 wt % total cannabinoids. In another embodiment, the cannabinoid extract comprises a total amount of cannabinoid(s) selected from: 50-75 wt %, 50-99 wt %, 75-99 wt %, 75-95 wt %, 80-99 wt %, 85-99 wt %, 90-99 wt %, 85-95 wt %, or 90-95 wt % cannabinoids.

In one embodiment, the total concentration of cannabinoid(s) in a composition of the present invention is 1-200 mg/mL. In further embodiments, the total concentration of cannabinoid(s) in a composition of the present invention is selected from: 1-5 mg/mL, 1-10 mg/mL, 1-50 mg/mL, 1-100 mg/mL, 5-50 mg/mL, 10-50 mg/mL, 10-100 mg/mL, 5-10 mg/mL, 10-15 mg/mL, 15-20 mg/mL, 20-30 mg/mL, 30-40 mg/mL, 40-50 mg/mL, 50-75 mg/mL, 75-100 mg/mL, 100-150 mg/mL, or 150-200 mg/mL. In another embodiment, the total concentration of cannabinoid(s) in a composition of the present invention is <0.001 mg/mL, 0.001-0.01 mg/mL, or 0.01-1 mg/mL.

In one embodiment, the total concentration of Δ9 THC in a composition of the present invention is selected from: 1-5 mg/mL, 1-10 mg/mL, 1-50 mg/mL, 1-100 mg/mL, 5-50 mg/mL, 10-50 mg/mL, 10-100 mg/mL, 5-10 mg/mL, 10-15 mg/mL, 15-20 mg/mL, 20-30 mg/mL, 30-40 mg/mL, 40-50 mg/mL, 50-75 mg/mL, 75-100 mg/mL, 100-150 mg/mL, or 150-200 mg/mL. In another embodiment, a composition of the present invention comprises <0.001 mg, 0.001-0.25 mg, or 0.25-1 mg.

The present invention includes a terpene selected from the group consisting of: abietane, alpha-bisabolol, alpha-phellandrene, alpha-pinene, beta-caryophyllene, beta-myrcene, beta-pinene, borneol, cadinene, camphene, camphor, carvacrol, caryophyllene acetate, caryophyllene oxide, cedrane, cembrene, citral, citronellol, copaene, dextro carvone, dextro fenchone, eucalyptol, eugenol, farnesene, gama-3-carene, gamma-terpinene, geraniol, geranyl acetate, guaiazulene, guaiene, humulene, isopulegol, labdane, limonene, linalool, longifolene, menthol, nerol, nerolidol, ocimene, ocimene, patchoulol, p-cymene, phytane, phytol, pinene, pulegone, retinal, retinol, sclarene, stemarene, stemoden, terpineol, terpinolele, terpinolene, texadiene, thymol, valencene, valencene, vetivazulene, zingiberene.

In one embodiment, the composition of the present invention comprises 0-50 wt % total terpene(s). In further embodiments, a composition of the present invention comprises a total amount of terpene(s) selected from: 0-0.1 wt %, 0-0.5 wt %, 0.5-1 wt %, 0-1 wt %, 0-5 wt %, 0-10 wt %, 0-25 wt %, 1-2 wt %, 2-3 wt %, 3-4 wt %, 4-5 wt %, 5-7.5 wt %, 5-10 wt %, 10-12.5 wt %, 10-15 wt %, 15-20 wt %, or 20-25 wt %, or 25-50% wt % terpene(s).

In another embodiment, the cannabinoid extract comprises a total amount of cannabinoid(s) and a total amount of terpene(s) selected from: 50-75 wt %, 50-99 wt %, 75-99 wt %, 75-95 wt %, 80-99 wt %, 85-99 wt %, 90-99 wt %, 85-95 wt %, 90-95 wt %, or >99 wt % cannabinoid(s); and 0-0.1 wt %, 0-0.5 wt %, 0.5-1 wt %, 0-1 wt %, 0-5 wt %, 0-10 wt %, 0-25 wt %, 1-2 wt %, 2-3 wt %, 3-4 wt %, 4-5 wt %, 5-7.5 wt %, 5-10 wt %, 10-12.5 wt %, 10-15 wt %, 15-20 wt %, or 20-25 wt %, or 25-50% wt % terpene(s).

In one embodiment, the terpenes and cannabinoids are co-extracted, i.e., extracted together. In another embodiment, some or all of the terpenes are extracted separately from the cannabinoids. In another embodiment, some or all of the terpenes are synthetic. In one embodiment, the total concentration of the terpene(s) in a composition of the present invention is selected from: 0.05-50 mg/mL, 0.05-0.1 mg/mL, 0.1-0.5 mg/mL, 0.5-1 mg/mL, 1-5 mg/mL, 5-10 mg/mL, 10-20 mg/mL, 20-30 mg/mL, 30-40 mg/mL, 40-50 mg/mL, 1-50 mg/mL, or 10-50 mg/mL.

A composition of the present invention may further comprise, inter alia, an additional surfactant, antioxidant, viscosity modifying agent, cytochrome P450 metabolic inhibitor, P-GP efflux inhibitor, or semi-solid inducer. Preferred antioxidants include ascorbyl palmitate, butylated hydroxy anisole, butylated hydroxy toluene, propyl gallate, α-tocopherol, γ-tocopherol, and mixed tocopherols. In one embodiment, the composition of the present invention further comprises an antioxidant(s) in the range of about 0.01% w/v to about 0.1% w/v.

Viscosity modifying agents include unmodified starches, pregelatinized starches, crosslinked starches, guar gum, xanthan gum, acacia, tragacanth, carrageenans, alginates, chitosan, precipitated calcium carbonate (PCC), polyvinyl pyrrolidone, polyethylene oxide, polyethylene glycols (PEG), polycarbophils, EUDRAGIT® series polymers (E, L, S, RL, RS, NE), hydroxymethylpropyl cellulose (HPMC), hydroxyethylcellulose (HEC), hydroxypropylmethylcelluose (HPC), carboxymethylcellose sodium (Na-CMC), ethylcellulose, cellulose acetate, and cellulose acetate phthalate, polyvinylacetate/polyvinylpyrrolidone (PVA/PVP), PVA/PEG graft copolymer, hydrogenated vegetable oils, polyglycolized esters of fatty acids, carnauba wax, stearyl alcohol, and beeswax, polyvinyl caprolactam-polyvinyl acetate-polyethylene glycol graft co-polymer, and combinations thereof.

Cytochrome P450 inhibitors include an agent that inhibits pre-systemic hepatic first pass metabolism, e.g., d-α-tocopheryl polyethylene glycol 1000 succinate, anise oil, cinnamon oil, coriander oil, grapefruit oil, lemon oil, orange oil, peppermint oil, ascorbyl palmitate, propyl gallate, and combinations thereof.

PGP efflux inhibitors includes an agent that inhibits PGP induced cellular efflux mechanisms, e.g., polyethoxylated castor oil derivatives, polyoxyethylene sorbitan monooleate, polyoxyethylene glycerides, and combinations thereof.

A composition of the present invention may comprise a semi-solid inducer, e.g., colloidal silicon dioxide, granulated fumed silicas, precipitated silicas, amorphous silica gel, magnesium aluminum silicates, sodium magnesium aluminum silicates, microcrystalline cellulose, talc, dicalcium phosphate anhydrous, isomaltose and combinations thereof.

In addition to a primary surfactant(s), a composition of the present invention may further comprise an additional co-surfactant(s) to improve the emulsification of the provided compositions. Examples of co-surfactants include glycerol, sodium stearate, potassium laurate, sodium dodecyl sulfate, sodium sulfosuccinate, polyglycol, fatty acid esters, quaternary ammonium salts, amine hydrochlorides and combination thereof.

A composition may comprise chelating agents in a final range of about 0.01% to about 0.5% w/v. Examples of chelating agents include ethylenediaminetetraacetic acid (EDTA), phosphoric acid, polyphosphates, polysaccharides, citric acid and combinations thereof.

A composition may also additionally comprise inactive ingredients selected from a group consisting of antiadherents, binders, coatings, disintegrants, flavours, colours, lubricants, glidants, sorbents, preservatives, sweeteners, edible carriers, and combinations thereof.

A composition may further comprise a pH adjusting agent, e.g., disodium hydrogen phosphate, sodium acetate, sodium bicarbonate, sodium phosphate tribasic, dipotassium hydrogen phosphate, phosphoric acid, acetic acid, lactic acid, fumaric acid, adipic acid, malic acid, tartaric acid, citric acid, hydrochloric acid, sulfuric acid, salts thereof, and combinations thereof. In one embodiment, the composition pH is in the range of about 6.5 to about 7.5. In a further embodiment, the composition pH is in the range of about 7.0 to about 7.5. In a further embodiment, the composition pH is in the range of about 6.5 to about 7.0.

A composition may additionally comprise an osmotic agent, e.g., glycerin, glucose, sucrose, sorbitol, sodium phosphate and combinations thereof.

A composition may further comprise a flavoring and/or taste-masking agent, e.g., glucose, fructose, sucrose, sorbitol, sucralose, saccharin sodium, sodium cyclamate, aspartame, neotame, acesulfame potassium, stevioside, sodium chloride, D-limonene, citric acid, xylitol and combinations thereof. In one preferred embodiment, the flavoring and/or taste-masking agent is sucralose.

A composition may also further comprise preservatives, e.g., methylparabens, ethylparabens, propylparabens, butylparabens, sorbic acid, acetic acid, propionic acid, sulfites, nitrites, sodium sorbate, potassium sorbate, calcium sorbate, benzoic acid, sodium benzonate, potassium benzonate, calcium benzonate, sodium metabisulfite, propylene glycol, benzaldehyde, butylated hydroxytoluene, butylated hydroxyanisole, formaldehyde donors, essential oils, monoglyceride, and combinations thereof.

A composition of the present invention may be formulated, e.g., as a delayed release, sustained release, pulsatile release, immediate release, fast-disintegrating (e.g., orally disintegrating), or other release dosage form. The dosage form may include drug polymer conjugates, microencapsulation, controlled-release tablet/capsule coating, pH or other stimuli sensitive materials, or combinations thereof.

In another embodiment, the invention provides for an edible product comprising a composition of the present invention. Edible products include a lozenge, candy (including hard candies/boiled sweets, lollipop, gummy candy, candy bar, etc.), chocolates, brownie, cookie, trail bar, crackers, dissolving strip, mint, pastry, bread, etc. Further included is chewing gum, although the base gum is not consumed.

In another embodiment, a composition of present invention is a pharmaceutical composition. In another embodiment, the composition/pharmaceutical composition is a unit dose of the composition/pharmaceutical composition. In one embodiment, the unit dose is for oral administration, i.e., an oral unit dosage form. In another embodiment, the unit dose is for sublingual (held under the tongue) or buccal (held between the cheek and gum) administration, i.e., a sublingual or buccal unit dosage form. In a further embodiment, the unit dose is a liquid, solid, or semi-solid.

The unit dose may be in the form of a syrup, drops, solution, suspension, tablet, bolus, troche, tincture, oral/buccal/sublingual spray, lozenge, dissolving strip, or capsule. In one embodiment, the capsule is a hard gelatin capsule, a soft gelatin capsule, a starch capsule or an enteric coated capsule. In a one embodiment, the unit dose is a hard gelatin capsule. In a further embodiment, the unit dose is a soft gelatin capsule. In another embodiment, the syrup, drops, solution, suspension, tablet, bolus, troche, tincture, spray, lozenge, or capsule is an oral unit dosage form and in another embodiment, the same is a sublingual or buccal unit dosage form.

In one embodiment, the unit dose comprises about 0.25-100 mg of at least one active ingredient, e.g., cannabinoid or cannabinoid extract. In another embodiment, the unit dose comprises about 0.25-0.5 mg of at least one active ingredient, e.g., cannabinoid or cannabinoid extract. In another embodiment, the unit dose comprises about 0.5-1 mg of at least one active ingredient, e.g., cannabinoid or cannabinoid extract. In another embodiment, the unit dose comprises about 1-2.5 mg of at least one active ingredient, e.g., cannabinoid or cannabinoid extract. In another embodiment, the unit dose comprises about 2.5-5 mg of at least one active ingredient, e.g., cannabinoid or cannabinoid extract. In another embodiment, the unit dose comprises about 5-7.5 mg of at least one active ingredient, e.g., cannabinoid or cannabinoid extract.

In another embodiment, the unit dose comprises about 0.5-15 mg of at least one active ingredient, e.g., cannabinoid(s) or cannabinoid extract. In another embodiment, the unit dose comprises about 0.5-2.5 mg of at least one active ingredient, e.g., cannabinoid(s) or cannabinoid extract. In another embodiment, the unit dose comprises about 2.5-1 mg of at least one active ingredient, e.g., cannabinoid(s) or cannabinoid extract. In another embodiment, the unit dose comprises about 2.5-5 mg of at least one active ingredient, e.g., cannabinoid(s) or cannabinoid extract. In another embodiment, the unit dose comprises about 5-7.5 mg of at least one active ingredient, e.g., cannabinoid(s) or cannabinoid extract. In another embodiment, the unit dose comprises about 5-10 mg of at least one active ingredient, e.g., cannabinoid(s) or cannabinoid extract. In another embodiment, the unit dose comprises about 5-15 mg of at least one active ingredient, e.g., cannabinoid(s) or cannabinoid extract. In another embodiment, the unit dose comprises about 7.5-10 mg of at least one active ingredient, e.g., cannabinoid(s) or cannabinoid extract. In another embodiment, the unit dose comprises about 10-12.5 mg of at least one active ingredient, e.g., cannabinoid(s) or cannabinoid extract. In another embodiment, the unit dose comprises about 12.5-15 mg of at least one active ingredient, e.g., cannabinoid(s) or cannabinoid extract. In another embodiment, the unit dose comprises about 15-20 mg of at least one active ingredient, e.g., cannabinoid(s) or cannabinoid extract. In another embodiment, the unit dose comprises about 20-30 mg of at least one active ingredient, e.g., cannabinoid(s) or cannabinoid extract. In another embodiment, the unit dose comprises about 30-40 mg of at least one active ingredient, e.g., cannabinoid(s) or cannabinoid extract. In another embodiment, the unit dose comprises about 40-50 mg of at least one active ingredient, e.g., cannabinoid(s) or cannabinoid extract. In another embodiment, the unit dose comprises about 50-60 mg of at least one active ingredient, e.g., cannabinoid(s) or cannabinoid extract. In another embodiment, the unit dose comprises about 60-70 mg of at least one active ingredient, e.g., cannabinoid(s) or cannabinoid extract. In another embodiment, the unit dose comprises about 70-75 mg of at least one active ingredient, e.g., cannabinoid(s) or cannabinoid extract. In another embodiment, the unit dose comprises about 70-80 mg of at least one active ingredient, e.g., cannabinoid(s) or cannabinoid extract. In another embodiment, the unit dose comprises about 80-90 mg of at least one active ingredient, e.g., cannabinoid(s) or cannabinoid extract. In another embodiment, the unit dose comprises about 90-100 mg of at least one active ingredient, e.g., cannabinoid(s) or cannabinoid extract. In another embodiment, the unit dose comprises about 100-150 mg of at least one active ingredient, e.g., cannabinoid(s) or cannabinoid extract. In another embodiment, the unit dose comprises about 150-200 mg of at least one active ingredient, e.g., cannabinoid(s) or cannabinoid extract. In another embodiment, the unit dose comprises about 0.5, about 1, about 5, about 7.5, about 10, about 12.5 mg or about 15 mg of at least one active ingredient, e.g., cannabinoid(s) or cannabinoid extract. In some embodiments, the cannabinoid is THC. In some embodiments, the cannabinoid is CDB. In other embodiments, the cannabinoids are THC and CBD.

In one embodiment, the total concentration of the terpene(s) in a composition of the present invention is selected from: 0.05-50 mg/mL, 0.05-0.1 mg/mL, 0.1-0.5 mg/mL, 0.5-1 mg/mL, 1-5 mg/mL, 5-10 mg/mL, 10-20 mg/mL, 20-30 mg/mL, 30-40 mg/mL, 40-50 mg/mL, 1-50 mg/mL, or 10-50 mg/mL.

In one embodiment, a unit dose comprises: 1.0-10 mg THC, 0.5-10 mg CBN, 30-120 mg CBD, 1.0-30 mg of at least one terpene, and 0-10 mg melatonin. In one embodiment, the one or more terpenes is beta-myrcene ('myrcene') and limonine. In another embodiment, the combined amount of THC and CBN is 1.5-10 mg or 1.5-5 mg. In another embodiment, the combined amount of terpenes is 1-20 mg. In another embodiment, the composition comprises 1.0-10 mg, 1.0-5.0 mg, 5.0-10 mg, 1.0-3.0 mg, 0.1-2.0 mg, 0.1-1.0 mg, 0.1-0.5 mg, 0.25-0.5 mg, 0.3-1 mg, 0.1 mg, 0.2 mg, 0.3 mg, 0.4 mg, 0.5 mg, 0.6 mg, 0.7 mg, 0.8 mg, 0.9 mg, 1 mg, 2 mg, 3 mg, 4 mg, or 5 mg of melatonin.

In one embodiment, the unit dose comprises: THC, CBN, CBD, myrcene, limonine, and melatonin; wherein the amount of THC is selected from 1.0-2.5 mg or 2.5-5.0 mg; the amount of CBN is selected from 0.5-1.0 mg, 1.0-2.5 mg, or 2.5-5.0 mg; the amount of CBD is selected from 20-40 mg, 30-50 mg, 40-60 mg, 60-80 mg, 80-100 mg, or 100-120 mg; the amount of myrcene is selected from 1.0-2.5 mg or 2.5-5.0 mg; the amount of limonine is selected from 5.0-10 mg or 10-15 mg; and the amount of melatonin is selected from 0.25-0.5 mg, 0.3-1.0 mg, 1.0-2.5 mg or 2.5-5.0 mg.

In another embodiment, the unit dose comprises: 1.0-10 mg THC; 0.5-10 mg CBN; 20-80 mg CBD; 1.0-4.0 mg myrcene; 1.0-16 mg limonine; and, 0.1-10 mg melatonin. In a further embodiment, the amount of CBN is 0.5-1.0 mg. In a further embodiment, the amount of melatonin is 0.25-1.0 mg or 0.25-0.5 mg.

In another embodiment, the unit dose comprises: 1.0-10 mg THC; 1.0-10 mg CBN; 20-120 mg CBD; 1.0-4.0 mg myrcene; 1.0-16 mg limonine; and, 0.1-10 mg melatonin. In a further embodiment, the amount of CBN is 0.5-1.0 mg. In a further embodiment, the amount of melatonin is 0.25-1.0 mg or 0.25-0.5 mg.

In another embodiment; the unit dose comprises; 1.0-10 mg THC; 1.0-10 mg CBN; 30-80 mg CBD; 1.0-4.0 mg myrcene; 1.0-16 mg limonine; and 1-10 mg melatonin. In a further embodiment, the amount of CBN is 0.5-1.0 mg. In a further embodiment, the amount of melatonin is 0.25-1.0 mg or 0.25-0.5 mg.

In another embodiment, the unit dose comprises: 1-5 mg THC; 0.5-5 mg CBN; 30-80 mg CBD; 1-30 mg one or more terpenes; and 0.1-5 mg melatonin. In another embodiment, the composition comprises: 2.5-5 mg THC; 2-5 mg CBN; 30-50 mg CBD; 1-5 mg myrcene; 5-10 mg limonine; and 0.3-5 mg melatonin. In one embodiment, the ratio of CBD:THC and CBD:CBN in one of the compositions for promoting sleep, reducing stress, and/or reducing anxiety are each equal to or greater than 5:1. In another embodiment, the composition comprises: 5 mg THC; 5 mg CBN; 40 mg CBD; 2 mg myrcene; 8 mg limonine; and 1 mg melatonin.

The compositions comprising THC, CBN, CBD, myrcene, limonine, and melatonin are useful for promoting sleep, reducing stress, and/or reducing anxiety. In one embodiment, the composition is useful for treating insomnia, interrupted sleep, jet-lag, stress, or anxiety. In a further embodiment, the insomnia is sleep-onset insomnia or sleep-maintenance insomnia. In a further embodiment, the insomnia is caused by stress, anxiety, food, caffeine, or alcohol.

A second aspect provides a method of making a composition of the present invention, said method comprising the steps of:

providing at least one active ingredient and a surfactant; and

combining said at least one active ingredient and said surfactant to form a mixture. In one embodiment, the mixture is an isotropic or homogeneous mixture.

In one embodiment, the at least one active ingredient is selected from a cannabinoid, cannabinoid extract, terpene, terpene extract, or combinations thereof. In a further embodiment, the active ingredient is a cannabinoid or cannabinoid extract.

In some embodiments, the invention provides a method of making a composition of the present invention, said method comprising the steps of:

providing at least one active ingredient; a surfactant; and, optionally, a fatty acid, monoglyceride, diglyceride, triglyceride, or a combination thereof;

combining said at least one active ingredient; said surfactant; and, optionally, a fatty acid, monoglyceride, diglyceride, triglyceride, or a combination thereof to form a mixture. In one embodiment, the mixture is an isotropic or homogeneous mixture.

In one embodiment, the at least one active ingredient is selected from a cannabinoid, cannabinoid extract, terpene, terpene extract, or combinations thereof. In a further embodiment, the at least one active ingredient is a cannabinoid or cannabinoid extract.

In one embodiment, the method of making the composition of the first aspect comprises the steps of:

providing at least one active ingredient, at least one surfactant, and at least one triglyceride; and

combining said at least one active ingredient, said surfactant(s), and said triglyceride to form a mixture. In one embodiment, the mixture is an isotropic or homogeneous mixture. In some embodiments, the triglyceride is an MCT or LCT, as provided herein. In one embodiment the at least one active ingredient is selected from a cannabinoid, cannabinoid extract, terpene, terpene extract, or combinations thereof. In a further embodiment, the at least one active ingredient is a cannabinoid or cannabinoid extract.

In another embodiment, the method of making the composition of the first aspect comprises the steps of:

Providing at least one active ingredient; at least one surfactant; and at least one triglyceride; wherein said surfactant is polysorbate 80, or D-α-Tocopherol polyethylene glycol 1000 succinate (TPGS) and/or lauroyl macrogol 32 glycerides (e.g., GELUCIRE® 44/14); and, wherein said triglyceride is a medium-chain triglyceride and/or long-chain triglyceride; and

combining said at least one active ingredient; said surfactant(s); and said triglyceride to form a mixture. In one embodiment, the mixture is an isotropic or homogeneous mixture. In some embodiments, the triglyceride is an MCT or LCT, as provided herein.

In one embodiment, the at least one active ingredient is selected from a cannabinoid, cannabinoid extract, terpene, or terpene extract. In a further embodiment, the at least one active ingredient is a cannabinoid or cannabinoid extract.

The invention further provides for a method for increasing at least one parameter selected from the group consisting of solubility, dissolution, oral bioavailability, Cmax, absorption, onset of action, for decreasing time to Tmax, or for decreasing intra-patient variability comprising the steps of:

Providing at least one active ingredient; a surfactant; and, optionally, a fatty acid, monoglyceride, diglyceride, triglyceride, or a combination thereof;

combining said at least one active ingredient; said surfactant; and, optionally, a fatty acid, monoglyceride, diglyceride, triglyceride, or a combination thereof to form an isotropic or homogeneous mixture. In some embodiments, the triglyceride is an MCT or LCT, as provided herein.

In one embodiment, the at least one active ingredient is selected from a cannabinoid, cannabinoid extract, terpene, terpene extract, or combinations thereof. In a further embodiment, the active ingredient is a cannabinoid or cannabinoid extract.

The formulations of the present invention can significantly decrease the amount of time for the onset of action of the at least one active ingredient. In one embodiment, the composition, e.g., cannabinoid composition, of the present invention has an onset of action within 15 minutes, 15-20 minutes, 20 minutes, 25 minutes, 30 minutes, or within 45 minutes post administration.

The formulations of the present invention can further significantly decrease the peak time (the time it takes for an active ingredient to reach maximum effect) of an active ingredient. In one embodiment, the composition, e.g., cannabinoid composition, of the present invention has a peak time within 90 minutes, within 80 minutes, within 70 minutes, within 60-70 minutes, within 60 minutes, within 50 minutes, within 45-60 minutes, within 45 minutes, within 40 minutes, or within 30 minutes post administration.

The formulations of the present invention can further significantly increase the peak effect, i.e., the maximum effect of an active ingredient, e.g., the psychotropic effect of THC.

In one embodiment, the method for enhancing at least one parameter selected from the group consisting of solubility, dissolution, oral bioavailability and absorption comprises the steps of:

providing at least one active ingredient, at least one surfactant, and at least one triglyceride, and

combining said at least one active ingredient, said surfactant(s) and said triglyceride(s) to form a mixture. In one embodiment, the mixture is an isotropic or homogeneous mixture. In some embodiments, the triglyceride is an MCT or LCT, as provided herein.

In one embodiment, the at least one active ingredient is selected from a cannabinoid, cannabinoid extract, terpene, terpene extract, or combinations thereof. In a further embodiment, the active ingredient is a cannabinoid or cannabinoid extract.

In another embodiment, said at least one triglyceride comprises a medium-chain triglyceride and/or long-chain triglyceride, and said at least one surfactant comprises polysorbate 80, or D-α-Tocopherol polyethylene glycol 1000 succinate (TPGS) and/or lauroyl macrogol 32 glycerides. In one embodiment, the mixture is an isotropic or homogeneous mixture.

A third aspect of the invention provides for a composition and method for promoting sleep, reducing stress, and/or reducing anxiety; the composition comprising THC, CBD, CBN. In a further embodiment, the composition comprises as least one terpene. In a further embodiment, the composition comprises at least two terpenes. In another embodiment, the composition further comprises melatonin. Although many of the compositions of the first aspect are also useful for promoting sleep, reducing stress, and/or reducing anxiety, the compositions of the third aspect are not limited to compositions comprising a surfactant, i.e., the formulations of the third aspect, in some cases, do not comprise a surfactant. In one embodiment, the composition further comprises at least one excipient. In one embodiment, the at least one excipient is a pharmaceutically acceptable excipient. In a further embodiment, the composition is a pharmaceutical composition.

In one embodiment, the invention provides for a unit dose of a composition of the third aspect, said unit dose comprising: 1.0-10 mg THC, 0.5-10 mg CBN, 30-120 mg CBD, 1.0-30 mg of at least one terpene, and 0-10 mg melatonin. In one embodiment, the one or more terpenes is beta-myrcene (‘myrcene’) and limonine. In another embodiment, the combined amount of THC and CBN is 1.5-10 mg or 1.5-5 mg. In another embodiment, the combined amount of terpenes is 1-20 mg. In another embodiment, the unit dose comprises 1.0-10 mg, 1.0-5.0 mg, 5.0-10 mg, 1.0-3.0 mg, 0.1-2.0 mg, 0.1-1.0 mg, 0.1-0.5 mg, 0.25-0.5 mg, 0.3-1 mg, 0.1 mg, 0.2 mg, 0.3 mg, 0.4 mg, 0.5 mg, 0.6 mg, 0.7 mg, 0.8 mg, 0.9 mg, 1 mg, 2 mg, 3 mg, 4 mg, or 5 mg of melatonin.

In one embodiment, the unit dose comprises: THC, CBN, CBD, myrcene, limonine, and melatonin; wherein the amount of THC is selected from 1.0-2.5 mg or 2.5-5.0 mg; the amount of CBN is selected from 0.5-1.0 mg, 1.0-2.5 mg, or 2.5-5.0 mg; the amount of CBD is selected from 20-40 mg, 30-50 mg, 40-60 mg, 60-80 mg, 80-100 mg, or 100-120 mg; the amount of myrcene is selected from 1.0-2.5 mg or 2.5-5.0 mg; the amount of limonine is selected from 5.0-10 mg or 10-15 mg; and the amount of melatonin is selected from 0.25-0.5 mg, 0.3-1.0 mg, 1.0-2.5 mg or 2.5-5.0 mg.

In another embodiment, the unit dose comprises: 1.0-10 mg THC; 0.5-10 mg CBN; 20-80 mg CBD; 1.0-4.0 mg myrcene; 1.0-16 mg limonine; and, 0.1-10 mg melatonin. In a further embodiment, the amount of CBN is 0.5-1.0 mg. In a further embodiment, the amount of melatonin is 0.25-1.0 mg or 0.25-0.5 mg.

In another embodiment, the unit dose comprises: 1.0-10 mg THC; 1.0-10 mg CBN; 20-120 mg CBD; 1.0-4.0 mg myrcene; 1.0-16 mg limonine; and, 0.1-10 mg melatonin. In a further embodiment, the amount of CBN is 0.5-1.0 mg. In a further embodiment, the amount of melatonin is 0.25-1.0 mg or 0.25-0.5 mg.

In another embodiment; the unit dose comprises; 1.0-10 mg THC; 1.0-10 mg CBN; 30-80 mg CBD; 1.0-4.0 mg myrcene; 1.0-16 mg limonine; and 1-10 mg melatonin. In a further embodiment, the amount of CBN is 0.5-1.0 mg. In a further embodiment, the amount of melatonin is 0.25-1.0 mg or 0.25-0.5 mg.

In another embodiment, the unit dose comprises: 1-5 mg THC; 0.5-5 mg CBN; 30-80 mg CBD; 1-30 mg one or more terpenes; and 0.1-5 mg melatonin. In another embodiment, the unit dose comprises: 2.5-5 mg THC; 2-5 mg CBN; 30-50 mg CBD; 1-5 mg myrcene; 5-10 mg limonine; and 0.3-5 mg melatonin. In one embodiment, the ratio of CBD:THC and CBD:CBN in one of the compositions/unit dose for promoting sleep, reducing stress, and/or reducing anxiety are each equal to or greater than 5:1. In another embodiment, the unit dose comprises: 5 mg THC; 5 mg CBN; 40 mg CBD; 2 mg myrcene; 8 mg limonine; and 1 mg melatonin.

In another embodiment, the composition/unit dose for promoting sleep, reducing stress, and/or reducing anxiety further comprises a surfactant, preferably polysorbate 80.

The compositions are useful for promoting sleep, reducing stress, and/or reducing anxiety. In one embodiment, the composition is useful for treating insomnia, interrupted sleep, jet-lag, stress, or anxiety. In a further embodiment, the insomnia is sleep-onset insomnia or sleep-maintenance insomnia. In a further embodiment, the insomnia is caused by stress, anxiety, food, caffeine, or alcohol.

In a related embodiment, the invention provides for a method of promoting sleep, reducing stress, and/or reducing anxiety, comprising administering an effective amount of a sleep promoting, stress reducing, and/or anxiety reducing composition of the present invention to a person in need thereof. In another embodiment, the invention relates to a method of treating insomnia, interrupted sleep, jet-lag, stress, or anxiety, comprising administering an effective amount of a composition of the present invention to a person suffering from insomnia, interrupted sleep, jet-lag, stress, or anxiety. In a further embodiment, the insomnia is sleep-onset insomnia or sleep-maintenance insomnia. In a further embodiment, the insomnia is cause by stress, anxiety, food, caffeine, or alcohol.

A fourth aspect of the present invention provides for a method of treating, preventing or ameliorating the symptoms of a disease, condition or pathology in an animal (e.g., human). In one embodiment, the disease, condition or pathology is selected from: Alzheimer Disease, Amyotrophic Lateral Sclerosis (ALS), pain, anxiety, nausea, vomiting, insomnia, restless leg syndrome (RLS), diabetes mellitus, dystonia, epilepsy, fibromyalgia, gastrointestinal disorders, inflammatory bowel disease, Crohn's disease, irritable bowel syndrome, gliomas, cancer, Hepatitis C, Human Immunodeficiency Virus (HIV) Huntington Disease, hypertension, incontinence, methicillin-resistant Staphyloccus aureus (MRSA), multiple sclerosis, osteoporosis, pruritus, rheumatoid arthritis, insomnia, sleep apnea, or Tourette Syndrome.

In one embodiment, the pain is chronic pain. In another embodiment, the pain is acute pain. In a further embodiment, the acute pain is a migraine. In a further embodiment, the pain is selected from any one of the following: post-herpetic neuralgia, trigeminal neuralgia, spinal cord injury pain, carpal tunnel syndrome, phantom limb, ischemic pain, pain resulting from sports injuries, back pain (e.g., low back pain), menstrual pain, gastrointestinal or urethral cramps, skin wounds, burns, or cancer pain. In a preferred embodiment, the pain is cancer pain.

In another embodiment, the nausea and/or vomiting results from a chemotherapy, e.g., cancer chemotherapy. In another embodiment, the nausea and/or vomiting results from opioid use.

In another embodiment, the method is for increasing socialization, increasing relaxation, inducing sleep, reducing the time needed to fall asleep, or for inducing a psychotropic effect (commonly known as a “high”). In another embodiment, the method is for reducing the amount of opioid(s) used by an animal suffering from pain or used by an animal addicted to an opioid.

In one embodiment, the animal is a human.

The composition may be administered once, twice, three, or four times a day, or as needed.

In one embodiment, the invention provides a method of reducing the intensity or duration of pain in a subject (i.e., an animal, e.g., human), in need thereof, comprising the step of administering to the subject an effective amount of a cannabinoid containing composition of the present invention. In a further embodiment, the method decreases pain intensity in the subject. In a further embodiment, the method decreases pain duration in the subject. In one embodiment, the pain is acute pain. In another embodiment, the pain is chronic pain. In some embodiments, the subject has reduced pain intensity for at least 4 hours, at least 6 hours, at least 8 hours, at least 12 hours, at least 18 hours, or at least 24 hours post administration. In one embodiment, the cannabinoid composition of the present invention has a maximum pain relieving effect between 1-4 hours or between 1.5-2.5 hours post administration. In another embodiment, the cannabinoid composition of the present invention has an onset of pain relieving effect within 15 minutes, 20 minutes, 25 minutes, 30 minutes, or within 45 minutes post administration.

In one embodiment, the invention provides a method of reducing or preventing nausea or vomiting in a subject in need thereof, comprising administering to the subject an effective amount of a cannabinoid containing composition of the present invention. In one embodiment, the nausea or vomiting is opioid induced nausea or vomiting. The opioid inducing the nausea or vomiting may be an opioid analgesic such as hydrocodone, oxycodone, oripavine, dihydromorphine, hydromorphinol, nicomorphine, dipropanoylmorphine, diacetyldihydromorphine, desomorphine, methyldesorphine, heterocodeine, benzylmorphine, dihydroheterocodeine, myrophine, pentamorphone, tramadol, fentanyl, etc. In one embodiment, the cannabinoid containing composition is administered 0-30 minutes, 30-60 minutes prior to administration of the opioid. In another embodiment, the cannabinoid containing composition is administered 60 minutes prior to administration of the opioid. In another embodiment, the cannabinoid containing composition is administered concurrently with the administration of the opioid. In one embodiment, the nausea or vomiting occurs after surgery and results from anesthesia.

In one embodiment, the subject has reduced intensity of nausea in the 2, hours, 3 hours, 4 hours, 5 hours, 6 hours, 8 hours, 12 hours, 18 hours, or 24 hours following initial administration of the cannabinoid containing composition. In one embodiment, the subject has reduced vomiting in the 4 hours, 6 hours, 8 hours, 12 hours, 18 hours, or 24 hours following initial administration of the cannabinoid containing composition. In one embodiment, the cannabinoid composition of the present invention has a maximum nausea or vomiting reducing effect between 1-4 hours, 1-3 hours, 2-4 hours, or between 1.5-2.5 hours post administration. In another embodiment, the cannabinoid composition of the present invention has an onset of nausea or vomiting reducing effect within 15 minutes, 20 minutes, 25 minutes, 30 minutes, or within 45 minutes post administration.

In one embodiment, the method of reducing nausea or vomiting in a subject includes reducing the occurrence of nausea or vomiting.

In one embodiment, the composition of the present invention has a Tmax that is about 1-6 hours. In a further embodiment, the Tmax is about 1-3 hours in a fasted subject. In a further embodiment, the Tmax is about 2-4 hours in a fasted subject.

In another embodiment, the composition of the present invention has an about 20-400% greater absorption in the 90 minutes following administration than MARINOL®. In another embodiment, the composition of the present invention has an about 20-400% greater absorption, 100-200%, 200-300%, or 300-400% in the 60 minutes following administration than MARINOL®.

In another embodiment, the composition of the present invention has an about 20-400%, 100-200%, 200-300%, or 300-400% less first-pass metabolism than MARINOL®.

### EXAMPLES

Cannabidiol was procured from CBD internationals and marijuana THC extract was procured from New England Treatment Access (NETA). GELUCIRE® 44/14, Peceol, Transcutol, Lauroglycol 90, Capryol 90, Labrafac 1349 and Geloil samples were from Gattafosse SAS, Saint-Priest, France. Poloxamer 124, PEG 25, PEG 400 and polyoxyethylene 10 oleyl ether (Oleth-10 or BRIJ 97) were procured from VWR. Vitamin E TPGS (d-alpha tocopheryl polyethylene glycol 1000 succinate) was procured from Antares health products. Polysorbate 80 was procured from Modernist Pantry and SOLUTOL® HS 15 (KOLLIPHOR® HS 15) was procured from BASF. SOLUTOL® HS 15 is a tradename for macrogol 15 hydroxystearate (also called polyoxyl 15 hydroxystearate) and contains soluble non-ionic surfactants (70%) and PEG (3) formed by the reaction of 12-hydroxystearic acid with ethylene oxide at alkaline pH (12).

GELUCIRE® 44/14 (Gattefossé) is a tradename for lauroyl macrogol 32 glycerides (synonyms: lauroyl polyoxyl-32 glycerides, PEG-32 lauroyl polyoxylglycerides or PEG-32 lauric glycerides) that is obtained by polyglycolysis of hydrogenated coconut oil (medium and long chain triacylglycerols) and PEG-32. It is composed of a defined admixture of C8-C18 mono-, di- and triacylglycerols (20% w/w), PEG-32 mono- and diesters and free PEG-32 (80% w/w). The main fatty acid present is lauric acid which accounts for 45% on average of the total fatty acids. See Jannin, V. OCL 16(4):267-272 (2009).

Compositions comprising of long chain triglycerides or medium chain triglycerides with a variety of surfactants were prepared and tested to determine whether they produce micro- and nano-emulsions via self-emulsifying mechanisms. Formation of self-emulsification was assessed using visual and particle size analysis.

Single Excipient Dissolution Studies:

1 g Cannabidiol (CBD) or THC extract was added to a 20 mL scintillation vial to which was added 10 mL of excipient (9 g) (surfactant or triglyceride). The resulting solution was stirred for 30 minutes at 25° C. in case of liquid excipients. Semisolid and solid excipients were heated to 8° C. (to convert them into a liquid state) and stirred for 30 minutes. Stirring was continued until CBD or THC was completely soluble in the excipient forming a clear solution. This clear solution was used for dissolution studies in water by adding 45 microliter in 12 mL water (0.375%) with continuous stirring at 25° C. The resulting emulsion was stirred for 2 hours before particle size measurement. The particle size was measured using Dynamic Light Scattering instrument (Malvern Zetasizer Nano).

In single excipient studies, all oils and surfactants demonstrated high solubility. To determine whether these excipients are self-emulsifying with cannabinoids, dilution studies in water were performed. The data for both CBD and Cannabinoid extract (Table 3) showed that oils do not form microemulsions, which was expected.

TABLE 3

| | | | | | Particle size |
|---|---|---|---|---|---|
| | | HLB | | Particle size | (Cannabinoid |
| Excipient | Type | Value | Emulsion | (CBD) | extract) |
| Poloxamer 124 | Surfactant | 16 | nanoemulsion | 39 nm | 66 nm |
| GELUCIRE ® 44/14 | Surfactant | 11 | nanoemulsion | 44 nm | 27 nm |
| TPGS | Surfactant | 13 | nanoemulsion | 47 nm | 50 nm |
| SOLUTOL ® HS 15 | Surfactant | 15 | nanoemulsion | 18 nm | 17 nm |
| PEG 25 | Co-solvent | 11 | nanoemulsion | 96 nm | 165 nm |
| Polysorbate 80 | Surfactant | 15 | nanoemulsion | 65 nm | 89 nm |
| PEG 400 | Co-solvent | 10 | microemulsion | 382 nm | 321 nm |
| BRIJ 97 | Surfactant | 12 | microemulsion | 212 nm | 35 nm |
| | | | (CBD); | | |
| | | | nanoemulsion | | |
| | | | (THC) | | |
| Peceol | Oil (LCT) | 2 | Phase | — | |
| | | | separation | | |
| Transcutol | Surfactant | 4 | Phase | — | |
| | | | separation | | |
| Lauroglycol 90 | Surfactant | 3 | Phase | — | |
| | | | separation | | |
| Capryol 90 | Oil (MCT) | 6 | Phase | — | |
| | | | separation | | |
| Labrafac 1349 | Oil (MCT) | 1 | Phase | — | |
| | | | separation | | |
| Geloil | Oil/Surfactant | 5 | Phase | — | |
| | | | separation | | |

The results showed that some surfactants and co-solvents form micro- or nano-emulsions while others do not. Successful surfactants and surfactant/co-solvent combinations were empirically selected based on experimental observation. The results confirm that empirical studies are necessary to identity compositions that efficiently self-emulsify to form stable micro- or nano-emulsions.

The single excipient data was used as an initial screen for candidate surfactants. The candidate surfactants were then used in compositions (both binary and ternary) that were screened to determine whether they were self-emulsifying.

Binary and Ternary Formulation Dissolution Studies:

THC extract, TPGS, GELUCIRE® 44/14, Polysorbate 80 (PS 80), LCT oil and MCT oil were mixed in a ratio as shown in Table 4 in a 20 mL scintillation vials.

TABLE 4

| | Extract | MCT | LCT | TPGS | GELUCIRE | PS 80 | Particle |
|---|---|---|---|---|---|---|---|
| Fln # | wt % | wt % | wt % | wt % | wt % | wt % | size (nm) |
| A1 | 10 | 0 | 0 | 45 | 45 | 0 | 1100 |
| A2 | 10 | 72 | 0 | 9 | 9 | 0 | Phase |
| | | | | | | | separation |
| A3 | 10 | 0 | 72 | 9 | 9 | 0 | 258 |
| A4 | 10 | 45 | 0 | 22.5 | 22.5 | 0 | 265 |
| A5 | 10 | 0 | 45 | 22.5 | 22.5 | 0 | Phase |
| | | | | | | | separation |
| A6 | 10 | 72 | 0 | 0 | 0 | 18 | 332 |
| A7 | 10 | 0 | 72 | 0 | 0 | 18 | 811 |

The resulting solutions were stirred for 30 minutes at 80° C. Stirring was continued until THC extract was completely soluble in the oil/surfactant mix, forming a clear solution. To this clear solution was added 12 mL water with continuous stirring at 25° C. The resulting emulsion was stirred for 2 hours before particle size measurement. The particle size was measured using Dynamic Light Scattering instrument (Malvern Zetasizer Nano).

Mixing of oils and surfactants and testing in aqueous dilution studies (Table 4) yielded unexpected results in which formulations consisting of a cannabinoid in medium chain triglyceride oil and surfactants (e.g. TPGS, GELUCIRE 44/14, Polysorbate 80) were self-emulsifying with a particle size between 200-350 nm, while formulations consisting of a cannabinoid in a long chain triglyceride oil and a surfactant or surfactants form either a coarse microemulsion or aggregate (i.e. no emulsion). The percentages of surfactant and oil in Table 5 are based on the percent volume (%w/v) of surfactant and oil, excluding THC. Physical and chemical stability assays at 1 month showed no changes.

Additional formulations were prepared for in vitro and in vivo testing, as shown in Tables 5 and 6. The amount of surfactant relative to oil was increased in the formulations of Tables 5 and 6 to determine the effect on particle size and stability. The results showed a significant decrease in particle size with increasing surfactant concentration. Formulations containing oil only (no surfactant) phase separated, i.e., no particles were formed. Additional surfactants, BRIJ 97 and Solutol HS 15, were also tested with the results shown in Table 6.

TABLE 5

| | | | Maisine | | | | | |
|---|---|---|---|---|---|---|---|---|
| | Extract | MCT | 35-1 (LCT) | Sesame oil | GELUCIRE | TPGS | PS 80 | Particle |
| Fln# | wt % | wt % | wt % | wt % | wt % | wt % | wt % | Size (nm) |
| A8 | 11 | 89 | 0 | 0 | 0 | 0 | 0 | — |
| A9 | 10 | 42 | 0 | 0 | 0 | 0 | 48 | 101 |
| A10 | 10 | 0 | 42 | 0 | 0 | 0 | 48 | 639 |
| A11 | 10 | 42 | 0 | 0 | 24 | 24 | 0 | 131 |
| A12 | 10 | 0 | 42 | 0 | 24 | 24 | 0 | — |
| A13 | 11 | 0 | 0 | 89 | 0 | 0 | 0 | — |

TABLE 6

| | | | | | | Solutol | |
|---|---|---|---|---|---|---|---|
| | Extract | MCT | LCT | PS 80 | BRIJ 97 | HS 15 | Particle |
| Fln # | wt % | wt % | wt % | wt % | wt % | wt % | Size (nm) |
| A14 | 10 | 48 | 0 | 42 | 0 | 0 | 101 |
| A15 | 10 | 0 | 48 | 42 | 0 | 0 | 639 |
| 16 | 11 | 24.5 | 0 | 64.5 | 0 | 0 | 26 |
| A17 | 11.5 | 0 | 24 | 64.5 | 0 | 0 | 354 |
| A18 | 9 | 47 | 0 | 0 | 44 | 0 | 223 |
| A19 | 11 | 0 | 45 | 0 | 44 | 0 | 645 |
| A20 | 9.5 | 23.5 | 0 | 0 | 67 | 0 | 353 |
| A21 | 10 | 0 | 23 | 0 | 67 | 0 | 572 |
| A22 | 11 | 47 | 0 | 0 | 0 | 42 | 126 |
| A23 | 11 | 0 | 47 | 0 | 0 | 42 | 1033 |
| A24 | 9 | 25 | 0 | 0 | 0 | 66 | 30 |
| A25 | 12 | 0 | 24 | 0 | 0 | 64 | 70 |
| A26 | 11 | 72 | 0 | 0 | 17 | 0 | 2061 |
| A27 | 10 | 0 | 73 | 0 | 17 | 0 | 1108 |
| A28 | 12 | 72 | 0 | 0 | 0 | 16 | 1794 |
| A29 | 9 | 0 | 74 | 0 | 0 | 17 | 1607 |
| A30 | 10 | 0 | 0 | 90 | 0 | 0 | 110 |
| A31 | 5 | 0 | 0 | 95 | 0 | 0 | 11 |
| A32 | 10 | 90 | 0 | 0 | 0 | 0 | Phase |
| | | | | | | | separation |

Dispersion and Dilution Behavior of Cannabinoid Compositions as a Function of Surfactant Content, Composition, and Chemistry.

Polysorbates 20, 40, 60 and 80 (or polyoxyethylene (20) sorbitan monoesters, where the lipid group is laurate, palmitate, stearate and oleate for polysorbates 20, 40, 60 and 80, respectively) and sorbitan monooleate (Span 80) were obtained from Croda Health Care or food-grade manufacturers (Modernist Pantry). For Hydrophile to Lipophile Balance (HLB) experiments, surfactant blends with varying HLB numbers between 6 and 14 were prepared by mixing Polysorbate 80 and Span 80 at different mass ratios. For higher HLB numbers from 14.9 to 16.7, pure polysorbate surfactants were used.

Cannabis extract distillate, or distillate, was obtained from New England Treatment Access (NETA, Franklin, Mass.). In-house cannabinoid potency analysis by RP-HPLC showed that the distillate was rich in Δ9-THC content (˜75%). Three other cannabinoids, cannabidiol (˜3.6%), cannabichromene (˜1.4%), tetrahydrocannabivarin (˜1.3%) and cannabinol (˜0.4%) accounted for another 6.7% of the distillate mass. Five other tested major cannabinoids, cannabidivarin, cannabigerolic acid, Δ8-tetrahydrocannabinol and tetrahydrocannabinolic acid were all below quantitation limit (<0.1%).

An Agilent 1200 HPLC system equipped with a reverse-phase analytical column and a UV detector was employed for cannabinoid potency determination. The absorbance signal at 220 nm was calibrated against freshly prepared standard curve using certified reference material for 10 major cannabinoids (Cerilliant). The accuracy and limit of quantitation (LOQ) values were typically 90-110% and <0.1%, respectively.

The distillate rich in Δ9-THC content was homogenized for at least 1 hour at 75° C. Distillate-surfactant formulations with varying surfactant content of 50%, 75% and 90% (where the remainder of the formulation was the distillate) were prepared by adding the required quantity of surfactant to the distillate, followed by thorough homogenization for at least 1 hour at 75° C. in glass vials. The volume accuracy of viscous liquids was ensured by using a calibrated positive displacement pipette. The homogeneity of the formulations was assessed by visual inspection on an illuminator.

Aqueous emulsions were prepared at 1.0 or 0.1% by adding the required volume of formulation to deionized water in clean, glass vials using a positive displacement pipette in clean, glass vials. The volume accuracy of viscous liquids was ensured by using a calibrated positive displacement pipette. After each dilution, the aqueous emulsion was vortexed for 10 seconds. Vials were visually inspected for clarity and turbidity on an illuminator and assigned a “turbidity rank” from 0 to 5 based on their apparent turbidity. Turbidity rank values of 0-5 corresponded to transparent, transparent to translucent, translucent, translucent to opaque, and opaque, respectively. Subsequently, emulsions were subjected to particle size analysis.

For particle size determination, an emulsion aliquot was loaded in UV-transparent disposable cuvettes. Time-averaged autocorrelation function data was acquired using a Malvern Instruments Zetasizer Nano DLS system at 22° C. and 90° detector angle. The manufacturer's software was used to calculate Z-average particle diameter and polydispersity values. Each sample was tested in 3 quasi-replicates and select samples were run in replicates to estimate data precision. Inter-replicate variation in Z-average particle size was typically ≤20%.

For this study, we identified a polysorbate-Span surfactant system as a suitable model to determine the dependence of emulsion particle size on apparent HLB number of the surfactant or surfactant blends. Here, all polysorbate surfactants had the same hydrophilic head group, while differences in HLB number was due to differences in the chain length or the degree of saturation of the lipid tail as summarized in Table 7. For polysorbates 20, 40 and 60, the lipid tail was a saturated lipid of increasing chain length, while that of polysorbate 80 was an unsaturated oleate group. Although Span 80 had the same lipid functionality as that of polysorbate 80, its HLB number was considerably lower than those of polysorbates since it is not ethoxylated. Therefore, HLB numbers between 6 and 14 were obtained by blending polysorbate 80 and Span 80 at different mass ratios, while HLB numbers 14.9, 15, 15.6, 16.7 corresponded to those of pure polysorbates 60, 80, 40 and 20, respectively.

TABLE 7
Surfactant characteristics

| Surfactant | Ester group | Lipid # | HLB number |
|---|---|---|---|
| Polysorbate 20 | Laurate | C12:0 | 16.7 |
| Polysorbate 40 | Palmitate | C16:0 | 15.6 |
| Polysorbate 60 | Stearate | C18:0 | 14.9 |
| Polysorbate 80 | Oleate | C18:1 | 15 |
| Span 80 | Oleate | C18:1 | 4.3 |

Emulsion Particle Size vs. Surfactant HLB Number at Fixed Formulation Composition and Dilution

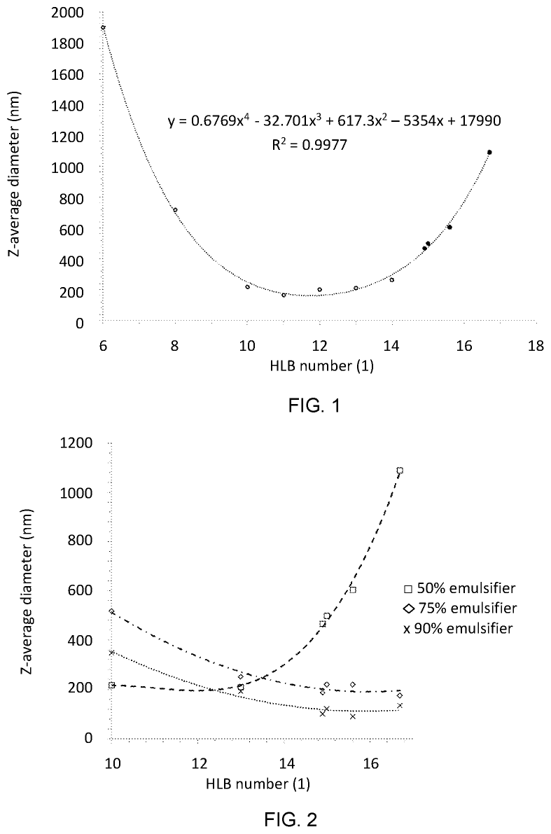

FIG. 1 shows the dependence of D, the Z-average particle diameter, on surfactant HLB number for 1.0 vol. % aqueous emulsions of formulations containing 50 vol. % surfactant. The D value showed a non-linear, parabolic dependence on the apparent HLB number of the surfactant. Starting at D≈1.9 μm for HLB=6, D values decreased gradually with increasing HLB number to a minimum of ≈180 nm at HLB=11-12. D value remained essentially constant for HLB=10-14, followed by a gradual increase in D with increasing HLB number to D≈1.1 μm at HLB=16.7. High D values for HLB <9 suggests that predominantly hydrophobic surfactants did not favor distillate microemulsions. Similarly, at a surfactant content of 50 vol. %, D values increased with increasing surfactant HLB number beyond 14. The particle size distribution indicates a preferred HLB of between about 9 to about 15, more preferably an HLB of about 10 to about 14 for distillate-surfactant formulations containing 50% surfactant. However, regardless of the surfactant HLB number, all compositions containing 50% surfactant formed turbid emulsions with high apparent turbidity with a “turbidity rank” value of 5. This suggested that despite having a Z-average diameter, D value≈200 nm, a significant population of particles exist in low surfactant content emulsions with HLB number 10-14 that are comparable in size or larger than the wavelength range of the visible light (400-700 nm). Presumably, a higher surfactant content was required to obtain clear, transparent micro-emulsions having a predominantly nanoparticle distribution.

Effect of Increasing Surfactant Content on Particle Size and its Dependence on HLB

Next, the content of surfactant (HLB≥10) was increased in distillate-surfactant formulations from 50 vol. % to 75 vol. %, and to 90 vol. %, while keeping the aqueous emulsion concentration constant at 1.0 vol. %. FIG. 2 shows the dependence of D value on HLB number at different surfactant content. Surprisingly, with increasing surfactant content the dependence of particle size on HLB number was reversed and D gradually decreased with increasing HLB number for formulations containing ≥75 vol. % surfactant. The results show an overall decrease in particle size with increasing HLB number at high surfactant concentrations.

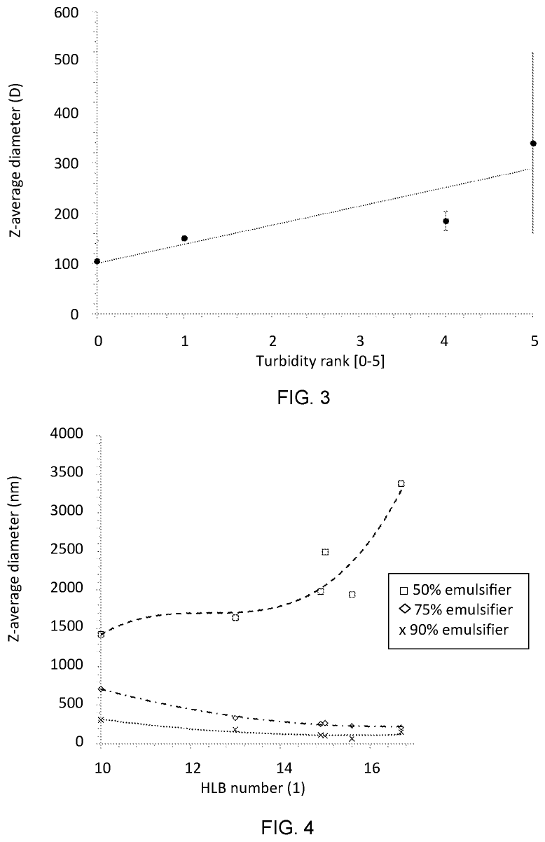

The appearance of 1.0% aqueous emulsions also changed with varying surfactant content. Formulations containing 75% surfactant formed 1.0% emulsions with a turbidity rank of 4-5, while those containing 90% surfactant formed 1.0% emulsions with a turbidity rank of 0-4. In general, apparent turbidity decreased with increasing HLB number. Also, compositions containing stearate fatty acids (polysorbate and Span 80) generally appeared more turbid. Apparent turbidity differences were most noticeable at 90% surfactant content, where turbidity rank of HLB=13 and 15 compositions were 4 and 1, respectively, while for all other, non-stearate high HLB compositions, HLB=14.9, 15.6 and 16.7, turbidity rank values were 0. As shown in FIG. 3, the apparent turbidity (turbidity rank) of the emulsions directly correlated with the Z-average particle, D data for 1.0% emulsions. Similar to low surfactant compositions, relatively high turbidity rank values for 1.0% emulsions of all 75% surfactant compositions and 90% surfactant compositions at low HLB values suggest a significant population of large particles that are able to interfere with visible light, despite their relatively low Z-average particle size measured by DLS. In contrast, the high transparency (low apparent turbidity) of 1.0% emulsions formed from 90% surfactant, high HLB compositions (HLB>14.9) suggest that a significant population of large particles do not exist in these emulsions.

Change of Particle Size Upon Further Aqueous Dilution

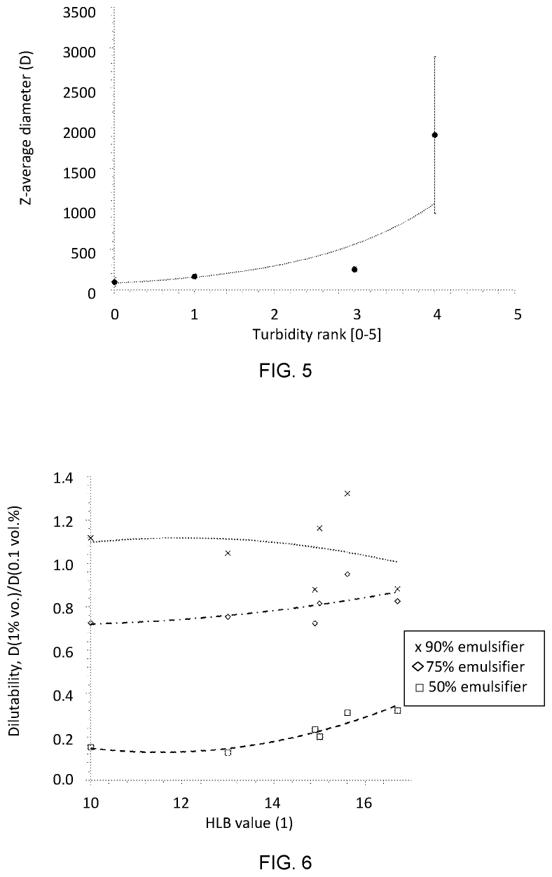

Changes in particle size upon further dilution of 1.0% aqueous emulsions were next investigated. FIG. 4 shows the dependence of D on HLB number at an aqueous emulsion concentration of 0.1%. The most pronounced change in emulsion particle size upon further dilution in water was observed for formulations with the lowest surfactant content. At 50% surfactant, D>1 μm for all 0.1% emulsions. With increasing surfactant content, the apparent change (increase) in particle size upon dilution decreased. FIG. 5 shows the direct relationship of apparent turbidity and Z-average particle size measured by DLS for 0.1% emulsions. Despite their increasing Z-average size with further dilution, the apparent turbidity of both 50% and 75% surfactant content 0.1% emulsions decreased in comparison to their 1.0% emulsions, presumably due to decreasing particle concentration. The turbidity rank of 0.1% emulsions were 4-5 and 3-4, for 50% and 75% surfactant compositions, respectively. Similar to their 1.0% emulsions, formulations containing 90% surfactant formed clear, transparent emulsions at an aqueous concentration of 0.1%, suggesting the absence of a significant population of large particles in these high surfactant content emulsions.

We defined a “solvent capacity” or “dilutability” parameter as the ratio of D value measured for 1.0% to D measured for 0.1% aqueous emulsions. For example, a dilutability parameter of 1.0 and 0.1 would correspond to a 0% and 900% increase in particle size upon dilution from 1.0% to 0.1%, respectively. FIG. 6 shows a comparison of dilutability curves as a function of surfactant HLB number at different surfactant content. These data suggest that regardless of the HLB number, the dilutability was low at 50% surfactant content. Increasing surfactant content to 75% significantly improved dilutability, while dilutability values were high and generally ≥0.9 for 90% surfactant content.

In Vivo Testing

The formulations of the present invention can be tested in vivo using methods well known in the art. For example, animals (e.g., beagle dogs) can be dosed with a unit dose of a cannabinoid formulation. Blood is then collected at various time points, e.g., 0.5, 1, 2, 4, 6, 8, 24, 30, 48 hours post-dose and stored (e.g., −80±10° C.) for subsequent analysis. Plasma/serum samples are then analyzed using validated methods for THC, CBD,11-Hydroxy THC, THC-COOH. PK analysis of the concentrations of test article are determined, for example, using a non-compartmental module of WinNonlin. Individual parameters, such as, Cmax, Tmax, AUC, t1/2, Vd, and Clearance are tabulated as appropriate.

Beverage Additive:

Flavoring oils and sweetener were added to formulations A30 and A31 to determine their effect on particle size (Table 8) and their suitability as beverage additives.

TABLE 8

| | Extract | PS 80 | Lemon | Peppermint | | Particle |
|---|---|---|---|---|---|---|
| Fln# | wt % | wt % | Oil | Oil | Sucralose | Size |
| A30 | 10 | 90 | 0 | 0 | 0 | 110 |
| A31 | 5 | 95 | 0 | 95 | 0 | 11 |
| A33 | 9.1 | 82.3 | 2.0 | 2.0 | 4.6 | 131 |
| A34 | 4.8 | 86.2 | 2.0 | 2.1 | 4.8 | 41 |

The results for A33 and A34 showed that the addition of flavor oils to the polysorbate 80-based formulation of A30 and A31 had little impact on particle size or dissolution of the cannabinoid extract.

Additional beverage additives (Table 9) were prepared and tested.

TABLE 9

| | wt. % | wt. % | | | | |
|---|---|---|---|---|---|---|
| | Polysorbate | THC- | wt. % | wt. % | wt. % | wt. % |
| Formulation | 80 | distillate | CBD | Sucralose | Peppermint | Lemon |
| BA9 | 86.9 | 0.1 | 4.5 | 4.6 | 2.0 | 1.9 |
| BA10 | 86.9 | 0.5 | 4.1 | 4.6 | 2.0 | 1.9 |

| | wt. % | wt. % | wt. % | | | |
|---|---|---|---|---|---|---|
| | Polysorbate | THC- | Steam | wt. % | wt. % | Flavor |
| Formulation | 80 | distillate | distillate | Sucralose | Flavor | description |
| BA11 | 90.0 | 5.0 | 0.0 | 5.0 | 0.0 | N/A |
| BA12 | 78.3 | 4.3 | 13.0 | 4.3 | 0.0 | N/A |
| BA13 | 85.7 | 4.8 | 0.0 | 9.5 | 0.0 | N/A |
| BA14 | 75.0 | 4.2 | 0.0 | 4.2 | 16.7 | Peppermint |
| BA15 | 75.0 | 4.2 | 0.0 | 4.2 | 16.7 | Lemon |
| BA16 | 75.0 | 4.2 | 0.0 | 4.2 | 16.7 | Artificial |
| | | | | | | Lemon |
| BA17 | 75.0 | 4.2 | 0.0 | 4.2 | 16.7 | Orange |
| BA18 | 75.0 | 4.2 | 0.0 | 4.2 | 16.7 | Artificial |
| | | | | | | Orange |
| BA19 | 75.0 | 4.2 | 0.0 | 4.2 | 16.7 | Artificial |
| | | | | | | Lime |
| BA20 | 75.0 | 4.2 | 0.0 | 4.2 | 16.7 | Dragonfruit |
| BA21 | 75.0 | 4.2 | 0.0 | 4.2 | 16.7 | Passionfruit |

Edibles—Gummies:

Table 10 lists the amounts of ingredients for different gummy batch sizes. Additional batch sizes can be scaled accordingly.

TABLE 10

| | Amount of Gummy Base Ingredient Per Batch Size | | | |
|---|---|---|---|---|
| | 1X | 2X | 10X | 20X |
| Gelatin (280 bloom) | 65 g | 130 g | 650 g | 1300 g |
| Water | 165 g | 330 g | 1650 g | 3300 g |
| Sugar | 225 g | 450 g | 2250 g | 4500 g |
| Corn Syrup | 245 g | 490 g | 2450 g | 4900 g |
| Xylitol | 26 g | 52 g | 260 g | 520 g |
| Citric Acid | 45 g | 90 g | 450 g | 900 g |
| Flavor | 15 g | 30 g | 150 g | 300 g |
| Color | 1 Drop | 2 Drops | 10 Drops | 20 Drops |

Flavors (colors) used were as follows: coconut (white), blueberry (blue), strawberry-melon (green; flavor ½ and ½), watermelon (pink: use ½ number of drops of red), blood orange (red and orange equal parts), mango (light orange: use ½ number of drops of orange).
1. Ingredients are scaled to the desired size. Gelatin and water are combined and mixed well. The mixture will immediately begin to bloom.
2. Sugar, xylitol and corn syrup are combined in a pot and heated on a stove until it reaches 250° F.
3. Bloomed gelatin is added to the sugar mixture in semi-small chunks and mix well with a spatula until all gelatin melts. Gelatin mixture is weighed and amount of cannabinoid formulation required for desired dose is calculated.
4. Color, flavor, cannabinoid formulation, and citric acid are added to the gelatin mixture. The cannabinoid formulation is a cannabinoid composition of the present invention. For example, the cannabinoid formulation may consist of cannabinoid extract dissolved in MCT (total percent between 10-80 w/v) and polysorbate 80 (total percent between 10-90 w/v). The ingredients are mixed well with a mixer and poured into a funnel. Foam is allowed to come to the top (5 minutes) before pouring.
5. The mixture is poured into square pans sprayed with a non-stick spray. Foam is not allowed to pour into pans. The funnel is topped off as needed with the remaining gummy mixture.
6. Trays are transferred to a rolling rack and allowed to set up slightly before moving to refrigerator.
7. Gummies are cut into cubes. Each gummy cube typically contains a cannabinoid dose ranging from 1-10 mg.

Clinical Observational Study

Observational studies including 23 subjects were conducted to compare the psychoactive effects of formulations A30 (90% Polysorbate 80 and 10% THC-distillate), A32 (90% MCT oil and 10% THC-distillate) and A34 (86.2% Polysorbate 80, 4.8% THC-distillate, 4.8% Sucralose, 2.0% Lemon oil and 2.1% Peppermint oil). A30 and A32 were supplied as capsules, while A34 was supplied as a beverage additive. The protocol was reviewed and approved by an independent ethics committee, and all subjects provided written informed consent. Subjects were recruited from two Medical Marijuana (MM) dispensaries in the Greater Boston Area. Subjects were asked to complete follow-up surveys (e.g., MM use behavior and effects) after each dispensary visit. All self-report data were collected via secure online research portal and identified only by the subject's unique ID number.

Effect: A34 and A30 provided a more intense effect than A32. Specifically, subjects experienced a 124% greater peak effect for A34 versus A32 and 60% greater peak effect for A30 versus A32. The effect of A30 was also less variable than that of A32, with 83% lower interquartile range with A30.

Onset time: Subjects reported significantly faster onset of the effects of A30 than that of A32 (α=0.016). The mean onset of effects was within 31-45 minutes for A30, while that of A32 was within 46-66 minutes. For A34, the onset time of effects was significantly faster, and consistently 15-20 minutes.

Peak time: Similar to onset time, peak times of the effects of A34 and A30 were also shorter than that of A32. On average, peak effects were observed within 80-90 for A32, within 60 minutes for A30, and within 45 minutes for A34.

Duration: The duration of effect that subjects experienced for A30 and A34 was similar to that of A32 but less variable, with 60% lower standard deviation.

While this invention has been particularly shown and described with references to preferred embodiments thereof, it will be understood by those skilled in the art that various changes in form and details may be made therein without departing from the scope of the invention encompassed by the appended claims.

1. A composition comprising:
(a) at least one cannabinoid or cannabinoid extract; and
(b) at least one surfactant
wherein the composition comprises no exogenously added fatty acid, monoglyceride, diglyceride, or triglyceride, or
wherein the only exogenously added fatty acid, monoglyceride, diglyceride, triglyceride, or combination thereof, is a flavoring oil.

2-204. (canceled)

205. The composition of claim 1, wherein the surfactant is polysorbate 80.

206. The composition of claim 1, further comprising an antioxidant.

207. The composition of claim 206, wherein the antioxidant is selected from the group consisting of ascorbyl palmitate, butylated hydroxy anisole, butylated hydroxy toluene, propyl gallate, a-tocopherol, y-tocopherol, and mixed tocopherols.

208. The composition of claim 1, wherein the surfactant is present in an amount of at least 60 wt %.

209. The composition of claim 208, wherein the surfactant is present in an amount of at least about 65 wt %.

210. The composition of claim 1, wherein the cannabinoid or cannabinoid extract is present in an amount of about 2.5 to about 5 wt %.

211. The composition of claim 1, wherein the cannabinoid or cannabinoid extract is present in an amount of at least about 5 wt %.

212. The composition of claim 1, wherein the at least one cannabinoid or cannabinoid extract comprises tetrahydrocannabinol, Δ9-tetrahydrocannabinol (THC), Δ8-tetrahydrocannabinol, a cannabis extract, tetrahydrocannabinolic acid (THCA), cannabidiolic Acid (CBDA), Δ8-tetrahydrocannabinol-DMH, Δ9-tetrahydrocannabinol propyl analogue (THCV), 11-hydroxy-tetrahydrocannabinol, 11-nor-9-carboxy-tetrahydrocannabinol, 5′-azido-Δ8-tetrahydrocannabinol, AMG-1, AMG-3, AM411, AM708, AM836, AM855, AM919, AM926, AM938, cannabidiol (CBD), cannabivarin (CBV), tetrahydrocannabivarin (THCV), cannabidivarin (CBDV), cannabichromevarin (CBCV), cannabigerovarin (CBGV), cannabigerol monomethyl ether (CBGM),cannabidiol propyl analogue (CBDV), cannabinol (CBN), cannabichromene (CBC), cannabichromene propyl analogue, cannabigerol (CBG), cannabicyclol (CBL), cannabielsoin (CBE), cannabinodiol (CBDL), and cannabitriol (CBTL), CP 47497, CP 55940, CP 55244, CP 50556, CT-3 or IP-751 (ajulemic acid), dimethylheptyl HHC, HU-210, HU-211, HU-308, WIN 55212-2, desacetyl-L-nantradol, dexanabinol, JWH-051, JWH-133, levonantradol, L-759633, nabilone, O-1184, cannabicyclohexanol (CP-47,497 C8 homolog), 10-hydroxycannabidiol, 1′,2′,3′,4′,5′-pentanorcannabinol-3-carboxylic acid, 1′-hydroxycannabinol, 11-hydroxycannabinol, 9-carboxy-11-norcannabinol, 1′-oxocannabinol, 11-nor-Δ8-THC-9-carboxylic acid, T-carboxy-3′,4′,5′-trinor-Δ9-THC, 5′-carboxy-Δ9-THC, 9-carboxy-11-nor-Δ9-THC, 9-carboxy-11-nor-Δ8-THC, [(6aR,10aR)-3-[(1S,2R)-1,2-dimethylheptyl]-6a,7,10,10a-tetrahydro-6, 6,9-trimethyl-6H-dibenzo[b,d]pyran-1-ol], 9-carboxy-11-nor-(2 or 4)-chloro-Δ8-THC, 8α-11-dihydroxy-Δ9-THC, 8β-11-Dihydroxy-Δ9-THC, 5′-Dimethylamino-Δ8-THC, 11-hydroxy-Δ9-THC, 1′-hydroxy-Δ9-THC (Isomer B), 11-hydroxy-Δ8-THC, 2′-hydroxy-Δ9-THC, 3′-hydroxy-Δ9-THC, 4′-hydroxy-Δ9-THC, 5′-hydroxy-Δ9-THC, 8α-hydroxy-Δ9-THC, 8β-hydroxy-Δ9-THC, 5′-methylamino-Δ8-THC, 5′-N-methyl-N-4-(7-nitrobenzofurazano)amino-Δ8-THC, (−)-trans-Δ8-THC, 5′-trimethylammonium-Δ8-THC phenolate, 5′-Trimethylammonium-11-hydroxy-Δ8-THC phenolate, or a mixture thereof.

213. The composition of claim 212, wherein the at least one cannabinoid or cannabinoid extract comprises THC, CBD, THCA or CBDA, or a combination thereof.

214. The composition of claim 1, wherein said composition is a non-aqueous composition.

215. The composition of claim 1, wherein the composition is a beverage additive.

216. A composition comprising an aqueous emulsion or a micellar dispersion of the self-emulsifying composition of claim 1 in an aqueous solvent.

217. The composition of claim 216, wherein particles of the aqueous emulsion or the micellar dispersion have an average particle size less than about 100 nm.

218. The composition of claim 217, wherein the average particle size is less than about 50 nm.

219. The composition of claim 1, wherein the composition is a solid or semi-solid composition.

220. The composition of claim 1, wherein the composition is an oral dosage form.

221. The composition of claim 220, wherein the oral dosage form is a capsule.

222. A unit dosage form of the composition of claim 215, wherein the unit dose contains between about 0.5 and about 2.5 mg of total cannabinoid(s).
